(19) United States
(12) Patent Application Publication
(10) Pub. No.: US 2021/0129751 A1
(43) Pub. Date: May 6, 2021

(54) SIDE AND REAR REFLECTION CONTROLLER AND SIDE AND REAR REFLECTION CONTROL METHOD

(71) Applicant: MITSUBISHI ELECTRIC CORPORATION, Tokyo (JP)

(72) Inventors: Mitsuo SHIMOTANI, Tokyo (JP); Yoshitaka NAKAMURA, Tokyo (JP); Yoshiharu ASAGA, Tokyo (JP)

(73) Assignee: MITSUBISHI ELECTRIC CORPORATION, Tokyo (JP)

(21) Appl. No.: 16/635,706

(22) PCT Filed: Sep. 15, 2017
(86) PCT No.: PCT/JP2017/033431

§ 371 Date: Jan. 31, 2020

(51) Int. Cl. B60R 1/00; H04N 7/18; G06K 9/00; H04N 5/262

(52) U.S. Cl. CPC B60R 1/00; H04N 7/181; G06K 9/00798; B60R 2300/804; B60R 2300/105; B60R 2300/20; H04N 5/2628

(57) ABSTRACT

The present invention is intended to encourage a driver to visually recognize a direction from the side and rear of a vehicle and requiring visual recognition by the driver at a complicated intersection. A side and rear reflection controller of the present invention includes: a geometry recognition unit that recognizes the geometry of an intersection having same direction entry lanes; a position recognition unit that recognizes the position of the own vehicle relative to the intersection; a visibility direction setting unit that sets a part from the side and rear of the own vehicle as a recommended visibility direction on the basis of the position of the own vehicle relative to the intersection and the same direction entry lanes; and a control unit that controls the side and rear reflection display device so as to present an image in the recommended visibility direction to the driver.

### TECHNICAL FIELD

The present invention relates to a technique of presenting a side and rear reflection to a driver of a vehicle.

### BACKGROUND ART

A side and rear reflection display device such as a mirror has been used as means for a driver to check the side and rear of a vehicle. The direction of the mirror is adjustable in response to operation by the driver, and is adjusted so as to allow a reference visibility range defined on the basis of the position of the vehicle to be recognized visually, for example.

Patent document 1 discloses a side and rear reflection display device that allows a driver to recognize the conditions of a driving lane and a next lane visually when a vehicle is driving on a straight road.

When a vehicle makes a right turn or left turn (hereinafter also called a “right or left turn”) to corner at an intersection, and if a visibility direction on the side and rear reflection display device is the same as a direction determined in the case of a straight road, it is impossible to visually recognize a moving object in the rear of the vehicle properly. In response to this problem, according to patent document 2, a state of a right or left turn of a vehicle is recognized, and the angle of a mirror is adjusted so as to allow a corner at an intersection in the left rear or right rear of the vehicle to be recognized visually, thereby adjusting a visibility direction for a driver.

### PRIOR ART DOCUMENTS

### Patent Documents

Patent document 1: Japanese Patent Application Laid-Open No. 2015-144407

Patent document 2: Japanese Patent Application Laid-Open No. 2010-89526

### SUMMARY

### Problem to be Solved by the Invention

According to the technique of patent document 2, when a vehicle makes a right or left turn at a simple intersection without traveling restriction, a driver is allowed to visually recognize the side and rear of the vehicle in the presence of a moving object likely to contact the vehicle. In the case of a complicated intersection configured to permit right or left turns in a plurality of lanes to the same direction at the intersection, a direction to be visually recognized by the driver largely changes in response to the position of the vehicle while the vehicle is cornering at the intersection. Hence, the technique of patent document 2 fails to provide the driver with the side and rear of the vehicle always responsive to the position of the vehicle properly while the vehicle is cornering at the intersection.

In view of the foregoing problem, the present invention is intended to encourage a driver to visually recognize a direction from the side and rear of a vehicle and requiring visual recognition by the driver at a complicated intersection.

### Means to Solve the Problem

A side and rear reflection controller of the present invention is a side and rear reflection controller that controls a side and rear reflection display device to present a reflection from the side and rear of an own vehicle to a driver, including: a geometry recognition unit that recognizes the geometry of an intersection having same direction entry lanes as a plurality of entry lanes allowing course change to the same direction; a position recognition unit that recognizes the position of the own vehicle relative to the intersection on the basis of the geometry of the intersection; a visibility direction setting unit that sets a part from the side and rear of the own vehicle as a recommended visibility direction on the basis of the position of the own vehicle relative to the intersection and the same direction entry lanes when the own vehicle changes a course at the intersection; and a control unit that controls the side and rear reflection display device so as to present an image in the recommended visibility direction to the driver.

A side and rear reflection control method of the present invention is a side and rear reflection control method of controlling a side and rear reflection display device to present a reflection from the side and rear of an own vehicle to a driver, including: recognizing the geometry of an intersection having same direction entry lanes as a plurality of entry lanes allowing course change to the same direction; recognizing the position of the own vehicle relative to the intersection on the basis of the geometry of the intersection; setting a part from the side and rear of the own vehicle as a recommended visibility direction on the basis of the position of the own vehicle relative to the intersection and the same direction entry lanes when the own vehicle changes a course at the intersection; and controlling the side and rear reflection display device so as to present an image in the recommended visibility direction to the driver.

### Effects of the Invention

A side and rear reflection controller of the present invention is a side and rear reflection controller that controls a side and rear reflection display device to present a reflection from the side and rear of an own vehicle to a driver, including: a geometry recognition unit that recognizes the geometry of an intersection having same direction entry lanes as a plurality of entry lanes allowing course change to the same direction; a position recognition unit that recognizes the position of the own vehicle relative to the intersection on the basis of the geometry of the intersection; a visibility direction setting unit that sets a part from the side and rear of the own vehicle as a recommended visibility direction on the basis of the position of the own vehicle relative to the intersection and the same direction entry lanes when the own vehicle changes a course at the intersection; and a control unit that controls the side and rear reflection display device so as to present an image in the recommended visibility direction to the driver. Thus, the driver can be encouraged to visually recognize a direction from the side and rear of the vehicle and requiring visual recognition by the driver at the complicated intersection having the same direction entry lanes as the recommended visibility direction.

A side and rear reflection control method of the present invention is a side and rear reflection control method of controlling a side and rear reflection display device to present a reflection from the side and rear of an own vehicle to a driver, including: recognizing the geometry of an intersection having same direction entry lanes as a plurality of entry lanes allowing course change to the same direction; recognizing the position of the own vehicle relative to the intersection on the basis of the geometry of the intersection; setting a part from the side and rear of the own vehicle as a recommended visibility direction on the basis of the position of the own vehicle relative to the intersection and the same direction entry lanes when the own vehicle changes a course at the intersection; and controlling the side and rear reflection display device so as to present an image in the recommended visibility direction to the driver. Thus, the driver can be encouraged to visually recognize a direction from the side and rear of the vehicle and requiring visual recognition by the driver at the complicated intersection having the same direction entry lanes as the recommended visibility direction.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a block diagram showing the configuration of a side and rear reflection display system according to a first embodiment;

FIG. 2 is a flowchart showing the operation of the side and rear reflection display system according to the first embodiment;

FIG. 3 is a block diagram showing the configuration of a side and rear reflection display system according to a second embodiment;

FIG. 4 is a flowchart showing the operation of the side and rear reflection display system according to the second embodiment;

FIG. 5 shows the position of a reference visibility direction and that of an own vehicle relative to each other;

FIG. 6 shows a reflection displayed in an electrical mirror pointed in a direction suited to a right reference visibility direction;

FIG. 7 shows the direction of an electrical mirror determined when the own vehicle makes a left turn at an intersection from an inner entry lane toward an inner exit lane relative to a cornering direction;

FIG. 8 shows a reflection displayed in an electrical mirror;

FIG. 9 shows the direction of an electrical mirror according to a comparative example determined when the own vehicle makes a left turn at an intersection from an outer entry lane toward an outer exit lane relative to a cornering direction;

FIG. 10 shows a reflection displayed in an electrical mirror;

FIG. 11 shows a reflection displayed in an electrical mirror;

FIG. 12 shows the direction of an electrical mirror according to the second embodiment determined under the same driving condition as that of FIG. 9;

FIG. 13 shows a reflection displayed in an electrical mirror;

FIG. 14 shows a reflection displayed in an electrical mirror;

FIG. 15 shows a method of setting a recommended visibility point in detail;

FIG. 16 shows the direction of an electrical mirror determined when the own vehicle makes a right turn at an intersection from an outer entry lane toward an outer exit lane relative to a cornering direction;

FIG. 17 shows the direction of an electrical mirror determined when the own vehicle makes a right turn at an intersection from an outer entry lane toward an outer exit lane relative to a cornering direction;

FIG. 18 shows the direction of an electrical mirror determined when the own vehicle makes a right turn at an intersection from an inner entry lane toward an inner exit lane relative to a cornering direction;

FIG. 19 shows the direction of an electrical mirror determined when the own vehicle makes a right turn at an intersection from an inner entry lane toward an outer exit lane relative to a cornering direction;

FIG. 20 is a block diagram showing the configuration of a side and rear reflection display system according to a fourth embodiment;

FIG. 21 is a block diagram showing the configuration of a side and rear reflection display system according to a fifth embodiment;

FIG. 22 shows a reflection displayed in an electrical mirror;

FIG. 23 shows a reflection displayed in an electrical mirror;

FIG. 24 is a block diagram showing the configuration of a side and rear reflection display system according to a sixth embodiment;

FIG. 25 is a flowchart showing the operation of the side and rear reflection display system according to the sixth embodiment;

FIG. 26 is a block diagram showing the configuration of a side and rear reflection display system according to a seventh embodiment;

FIG. 27 shows a relationship between an image captured by a wide-angle camera and a trimming range;

FIG. 28 shows an angle of view of the wide-angle camera and an angle of view of the trimming range;

FIG. 29 is a flowchart showing the operation of the side and rear reflection display system according to the seventh embodiment;

FIG. 30 is a block diagram showing the configuration of a side and rear reflection display system according to an eighth embodiment;

FIG. 31 shows a composite image;

FIG. 32 shows an angle of view of a camera;

FIG. 33 is a block diagram showing the configuration of a side and rear reflection display system according to a ninth embodiment;

FIG. 34 shows an example of an image captured by the wide-angle camera and displayed in a horizontal monitor;

FIG. 35 shows image processing by a processing unit;

FIG. 36 shows image processing by the processing unit;

FIG. 37 is a block diagram showing the configuration of a side and rear reflection display system according to a tenth embodiment;

FIG. 38 is a flowchart showing the operation of the side and rear reflection display system according to the tenth embodiment;

FIG. 39 shows a hardware configuration of a side and rear reflection display device;

FIG. 40 shows a hardware configuration of the side and rear reflection display device; and

FIG. 41 shows an exemplary configuration of a side and rear reflection controller according to the second embodiment configured using the own vehicle and a server.

### DESCRIPTION OF EMBODIMENT(S)

### First Embodiment

FIG. 1 is a block diagram showing the configuration of a side and rear reflection display system according to a first embodiment. The side and rear reflection display system of the first embodiment includes a side and rear reflection controller 101 and a side and rear reflection display device 21.

The side and rear reflection display device 21 is a device to be mounted on an own vehicle and to be used for presenting a reflection in a partial direction from the side and rear of the own vehicle to a driver of the own vehicle. In this description, a vehicle on which the side and rear reflection display device is mounted and a vehicle other than the former vehicle are distinguished from each other by naming the former as an “own vehicle” and the latter as a “different vehicle.”

The side and rear reflection controller 101 controls display on the side and rear reflection display device 21. The side and rear reflection controller 101 includes a geometry recognition unit 11, a position recognition unit 12, a visibility direction setting unit 13, and a control unit 14.

The geometry recognition unit 11 recognizes the geometry of an intersection when the own vehicle enters the intersection having same direction entry lanes as a plurality of entry lanes allowing course change to the same direction. The geometry of the intersection includes the size and position of each part of the intersection, and course restriction on each lane, for example. The geometry recognition unit 11 recognizes course restriction on a lane in which the own vehicle is driving and course restriction on a different lane, thereby allowing detection of the presence or absence of the same direction entry lanes or the positions of such lanes relative to each other. Further, the geometry recognition unit 11 can recognize course restriction on a lane on the basis of road marking, for example.

The position recognition unit 12 recognizes the position of the own vehicle relative to the intersection on the basis of the geometry of the intersection recognized by the geometry recognition unit 11. The position recognition unit 12 recognizes the location of the own vehicle relative to each part of the intersection, for example.

The visibility direction setting unit 13 sets a partial direction from the side and rear of the own vehicle as a recommended visibility direction. The side and rear of the own vehicle means the right rear and the left rear of the own vehicle. The recommended visibility direction is determined on the basis of the position of the own vehicle relative to the intersection and the same direction entry lanes.

The control unit 14 controls the side and rear reflection display device 21 so as to present a reflection in the recommended visibility direction to the driver.

Under control by the control unit 14, the side and rear reflection display device 21 presents the reflection in the recommended visibility direction to the driver. This allows the driver to visually recognize the reflection in the recommended visibility direction. As the recommended visibility direction is determined on the basis of the position of the own vehicle relative to the intersection and the same direction entry lanes, the driver can visually recognize a direction requiring visual recognition responsive to the position of the own vehicle in the intersection using the side and rear reflection display device 21.

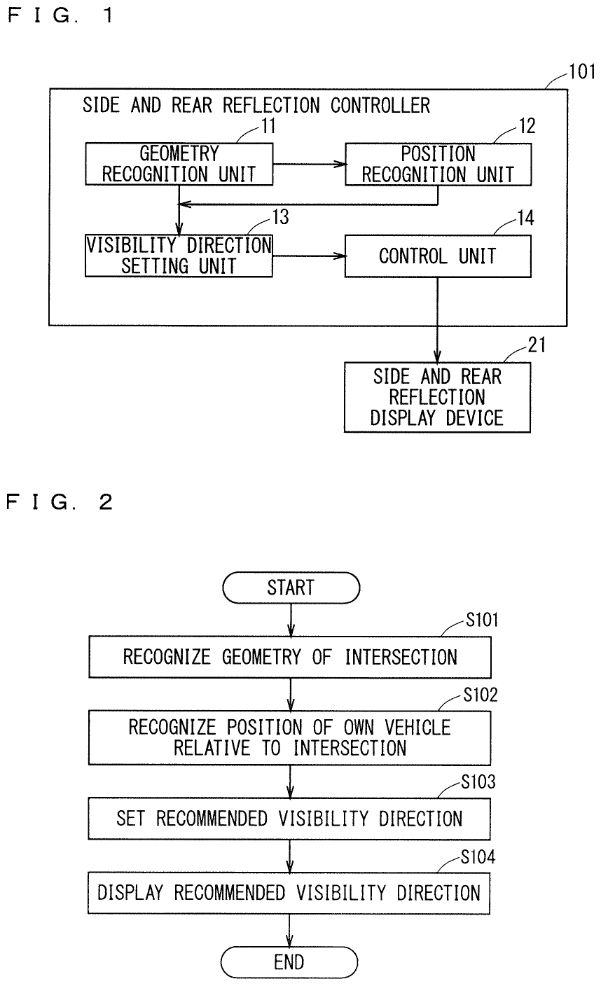

FIG. 2 is a flowchart showing the operation of the side and rear reflection display system according to the first embodiment. The operation of the side and rear reflection display system according to the first embodiment will be described next by referring to FIG. 2.

First, the geometry recognition unit 11 recognizes the geometry of an intersection (step S101). Next, the position recognition unit 12 recognizes the position of an own vehicle relative to the intersection on the basis of the geometry of the intersection recognized by the geometry recognition unit 11 in step S101 (step S102). Then, the visibility direction setting unit 13 sets a recommended visibility direction (step S103). Finally, the control unit 14 controls the side and rear reflection display device 21 to make the side and rear reflection display device 21 display the recommended visibility direction (step S104).

### Effects of First Embodiment

The side and rear reflection controller of the first embodiment is the side and rear reflection controller 101 that controls the side and rear reflection display device 21 to present a reflection from the side and rear of an own vehicle to a driver. The side and rear reflection controller 101 includes: the geometry recognition unit 11 that recognizes the geometry of an intersection having same direction entry lanes as a plurality of entry lanes allowing course change to the same direction; the position recognition unit 12 that recognizes the position of the own vehicle relative to the intersection on the basis of the geometry of the intersection; the visibility direction setting unit 13 that sets a part from the side and rear of the own vehicle as a recommended visibility direction on the basis of the position of the own vehicle relative to the intersection and the same direction entry lanes when the own vehicle changes a course at the intersection; and the control unit 14 that controls the side and rear reflection display device so as to present an image in the recommended visibility direction to the driver. Thus, the side and rear reflection controller 101 allows the driver to visually recognize a direction requiring visual recognition responsive to the position of the own vehicle in the intersection using the side and rear reflection display device 21.

A side and rear reflection control method of the first embodiment is a side and rear reflection control method of controlling the side and rear reflection display device 21 to present a reflection from the side and rear of an own vehicle to a driver. The side and rear reflection control method includes: recognizing the geometry of an intersection having same direction entry lanes as a plurality of entry lanes allowing course change to the same direction; recognizing the position of the own vehicle relative to the intersection on the basis of the geometry of the intersection; setting a part from the side and rear of the own vehicle as a recommended visibility direction on the basis of the position of the own vehicle relative to the intersection and the same direction entry lanes when the own vehicle changes a course at the intersection; and controlling the side and rear reflection display device so as to present an image in the recommended visibility direction to the driver. Thus, the side and rear reflection control method of the first embodiment allows the driver to visually recognize a direction requiring visual recognition responsive to the position of the own vehicle in the intersection using the side and rear reflection display device 21.

### Second Embodiment

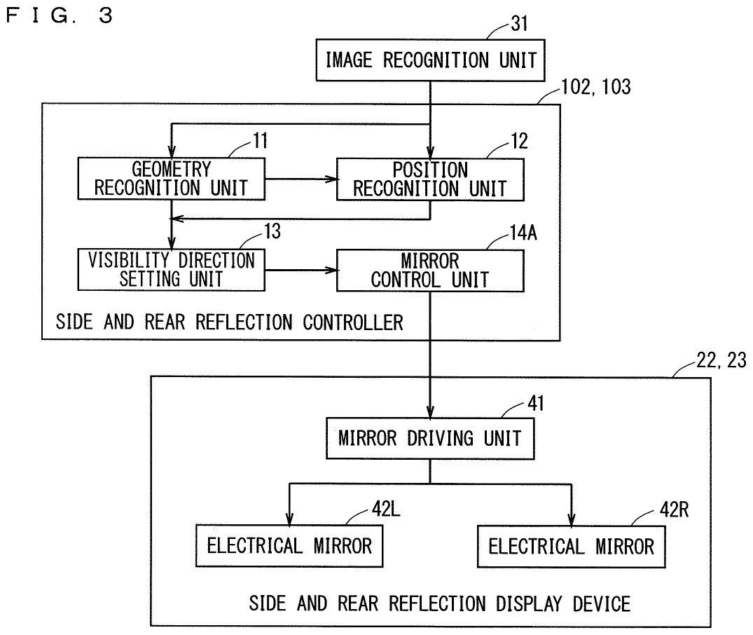

FIG. 3 is a block diagram showing the configuration of a side and rear reflection display system according to a second embodiment. The side and rear reflection display system of the second embodiment includes a side and rear reflection controller 102, a side and rear reflection display device 22, and an image recognition device 31. A structure equal to or corresponding to that in the other embodiments is given the same sign in FIG. 3 and will be described with the same sign.

The side and rear reflection controller 102 controls display on the side and rear reflection display device 22. The side and rear reflection controller 102 includes the geometry recognition unit 11, the position recognition unit 12, the visibility direction setting unit 13, and a mirror control unit 14A.

The image recognition device 31 captures an image of a periphery of an own vehicle using a camera mounted on the own vehicle and performs image recognition on the captured image, thereby recognizing a distance between the capturing target and the own vehicle. Information about the distance between the capturing target and the own vehicle recognized by the image recognition device 31 is input as image recognition information to the geometry recognition unit 11.

The geometry recognition unit 11 acquires the image recognition information from the image recognition device 31, and recognizes the geometry of a road in a neighborhood of the own vehicle including course restriction on a lane in which the own vehicle is driving and course restriction on a different lane on the basis of the acquired image recognition information.

The position recognition unit 12 recognizes the position of the own vehicle relative to an intersection on the basis of the geometry of the intersection recognized by the geometry recognition unit 11. The position of the own vehicle relative to the intersection recognized by the position recognition unit 12 is a distance and a direction of the own vehicle relative to a reference point such as a corner of the intersection, for example.

The visibility direction setting unit 13 recognizes a part of the side and rear of the own vehicle as a recommended visibility direction on the basis of the position of the own vehicle relative to the intersection and the position of the own vehicle relative to same direction entry lanes recognized by the position recognition unit 12. A method of setting the recommended visibility direction by the visibility direction setting unit 13 will be described later. Further, the visibility direction setting unit 13 sets a particular direction from the side and rear of the own vehicle and based on the own vehicle as a reference visibility direction. The recommended visibility direction and the reference visibility direction will be described later.

The mirror control unit 14A controls a mirror driving unit 41.

The side and rear reflection display device 22 includes the mirror driving unit 41, an electrical mirror 42L, and an electrical mirror 42R. The electrical mirror 42L is attached to the front of the left door of the own vehicle, and used for presenting a reflection from the left rear of the own vehicle displayed in its mirror surface to a driver. The electrical mirror 42R is attached to the front of the right door of the own vehicle, and used for presenting a reflection from the right rear of the own vehicle displayed in its mirror surface to the driver. The indexes L and R in the reference signs of the electrical mirrors 42L and 42R show the left side and the right side respectively. This also applies to a different constituting element given a reference sign with an index L or R.

The mirror control unit 14A of the side and rear reflection controller 102 decides the direction of the mirror surface of each of the electrical mirrors 42L and 42R (hereinafter simply called the “direction of each of the electrical mirrors 42L and 42R”) so as to cause the driver to visually recognize a reflection in the recommended visibility direction or a reflection in the reference visibility direction, and controls the mirror driving unit 41 in conformity with the decided direction.

In the side and rear reflection display device 22, the mirror driving unit 41 adjusts the direction of each of the electrical mirrors 42L and 42R under control by the mirror control unit 14A. By doing so, the reflection in the recommended visibility direction or the reflection in the reference visibility direction is displayed in each of the electrical mirrors 42L and 42R. Displaying the reflection in the recommended visibility direction or the reflection in the reference visibility direction in each of the electrical mirrors 42L and 42R means that the reflection in the recommended visibility direction or the reflection in the reference visibility direction appears in the mirror surface of each of the electrical mirrors 42L and 42R when each of the electrical mirrors 42L and 42R is visually recognized from the direction of the driver.

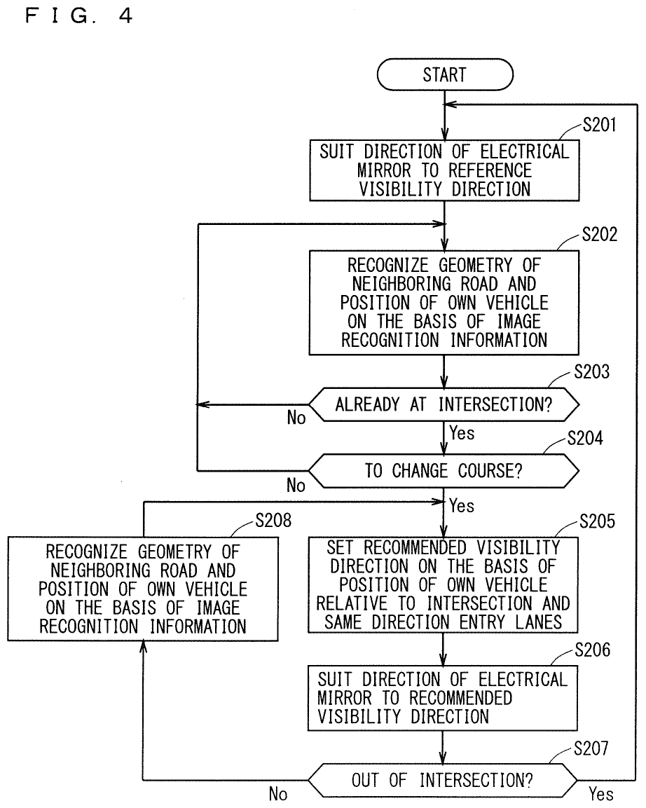

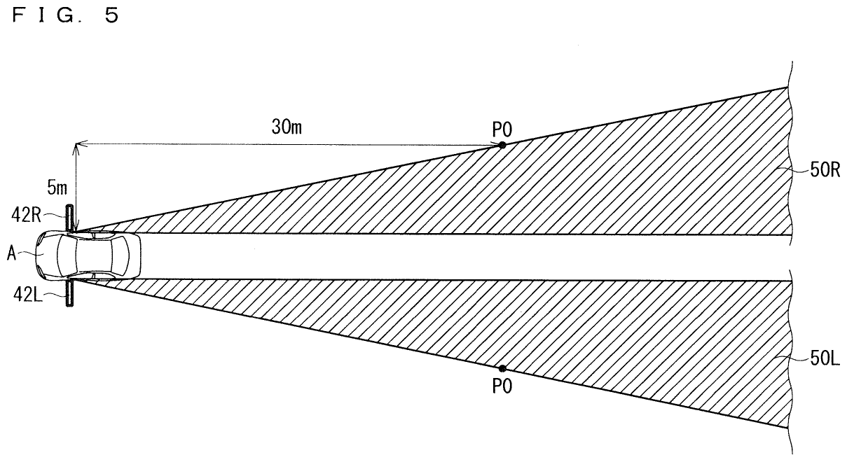

FIG. 4 is a flowchart showing the operation of the side and rear reflection display system according to the second embodiment. The operation of the side and rear reflection display system according to the second embodiment will be described next by referring to FIG. 4. The flow of FIG. 4 is started to coincide with timing of turning-on of an accessory power supply of an own vehicle, and continues until the accessory power supply is turned off, for example.

First, the mirror control unit 14A controls the mirror driving unit 41 to suit the direction of the electrical mirror 42L or 42R to a reference visibility direction (step S201). More specifically, the direction of the electrical mirror 42L or 42R is adjusted in such a manner that a reflection in the reference visibility direction appears in the mirror surface of the electrical mirror 42L or 42R when the electrical mirror 42L or 42R is visually recognized from the direction of a driver. The reference visibility direction may be set freely by the driver, may be a direction set last time, or may be set automatically on the basis of the positions of the eyes of the driver, for example.

Next, on the basis of image recognition information from the image recognition device 31, the geometry recognition unit 11 recognizes the geometry of a road in a neighborhood of the own vehicle, and the position recognition unit 12 recognizes the position of the own vehicle relative to the neighboring road (step S202). The neighboring road means a road within a range of a radius of 10 m or less from the own vehicle, for example.

Next, the visibility direction setting unit 13 determines whether the own vehicle has entered an intersection on the basis of the position of the own vehicle relative to the neighboring road (step S203). If the own vehicle has not entered the intersection, the processing by the side and rear reflection display system returns to step S202.

If the own vehicle has entered the intersection, the visibility direction setting unit 13 determines whether the own vehicle is to change a course (step S204). On the basis of a driving path of the own vehicle, the visibility direction setting unit 13 can determine that the own vehicle is to change a course if the own vehicle approaches either edge of a lane or deviates from a lane, for example. The visibility direction setting unit 13 may determine the presence or absence of the intention to change a course according to indication on an indicator of the own vehicle.

If the own vehicle is not to change a course, the processing by the side and rear reflection display system returns to step S202. If the own vehicle is to change a course, the visibility direction setting unit 13 sets a recommended visibility direction on the basis of the position of the own vehicle relative to the intersection and same direction entry lanes (step S205). A method of setting the recommended visibility direction will be described later.

Next, the mirror control unit 14A controls the mirror driving unit 41 to suit the direction of the electrical mirror 42L or 42R to the recommended visibility direction (step S206).

Next, the visibility direction setting unit 13 determines whether the own vehicle has exited the intersection on the basis of the position of the own vehicle relative to the intersection (step S207).

If the own vehicle has not exited the intersection, the geometry recognition unit 11 recognizes the geometry of a road in a neighborhood of the own vehicle on the basis of image recognition information from the image recognition device 31, and the position recognition unit 12 recognizes the position of the own vehicle relative to the neighboring road (step S208). Then, the processing by the side and rear reflection display system returns to step S205. If the own vehicle has exited the intersection, the processing by the side and rear reflection display system returns to step S201.

The reference visibility direction will be described. One reference visibility direction is set for each of the right rear and the left rear of the own vehicle.

FIG. 5 shows the position of a reference visibility direction and that of an own vehicle A relative to each other. A reference visibility direction 50R is set in the right rear of the own vehicle A. A reference visibility direction 50L is set in the left rear of the own vehicle A. With a point separated rightward by 5 m and rearward by 30 m from the own vehicle A defined as a reference visibility point P0, the reference visibility direction 50R is defined as a direction extending from the right side of the own vehicle A to the reference visibility point P0. The reference visibility direction 50L is bilaterally symmetric to the reference visibility direction 50R with respect to the own vehicle A. In this way, the reference visibility directions are defined as relative directions with respect to the own vehicle A.

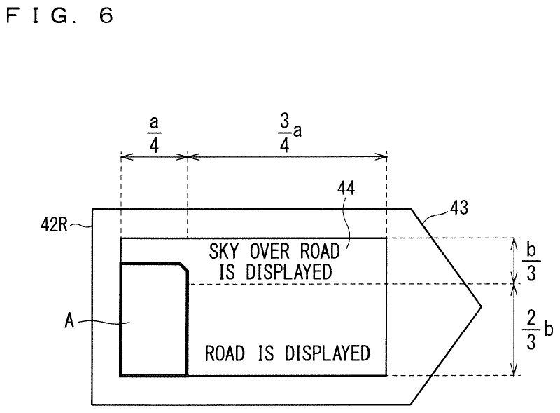

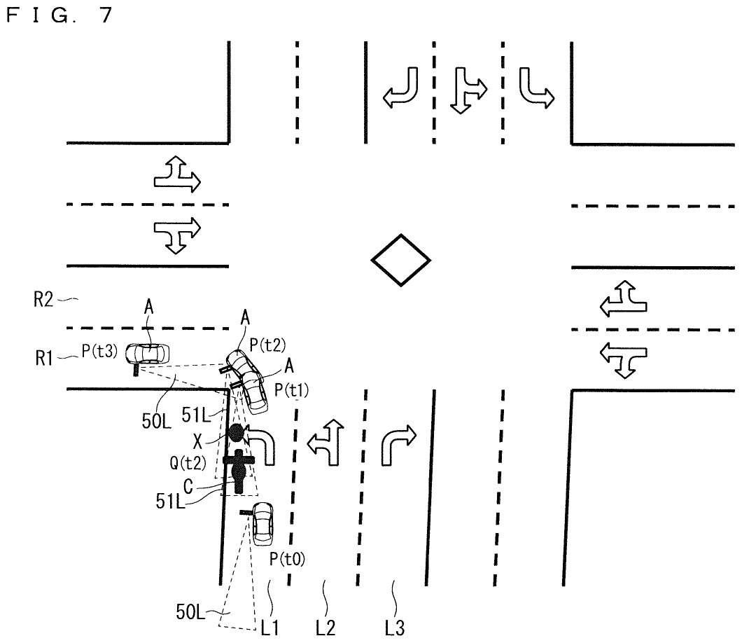

FIG. 6 shows a reflection displayed in the electrical mirror 42R pointed in a direction suited to the reference visibility direction 50R. The electrical mirror 42R includes a housing 43 and a mirror surface 44. The size of the mirror surface 44 in a horizontal direction is defined as a, and the size of the mirror surface 44 in a vertical direction is defined as b. The right body side surface of the own vehicle A is displayed in a region ranging a/4 from the left edge of the mirror surface 44. The reference visibility direction 50R is displayed in the other region of the mirror surface 44. Further, a road including a driving lane, a next lane or the like is displayed in a region ranging 2b/3 from the lower edge of the mirror surface 44, and the sky over the road is displayed in the other region. While the reflection displayed in the electrical mirror 42R is described herein, a reflection is displayed in the same way in the electrical mirror 42L pointed in a direction suited to the reference visibility direction 50L.

As shown in FIG. 6, as each the electrical mirrors 42L and 42R is for display of the side and rear of the own vehicle A, a driver can easily grasp the position of the own vehicle A and that of the side and rear relative to each other. A “reflection displayed in the electrical mirror 42R” means a reflection displayed in the mirror surface 44 when the driver sees the mirror surface 44 of the electrical mirror 42R.

For the convenience of description, in this embodiment, the reference visibility direction is defined in the manner shown in FIGS. 5 and 6. However, the reference visibility direction is not limited to this definition. For example, a reference visibility direction in the right mirror and that in the left mirror may be asymmetric to each other. Additionally, a road including a driving lane, a next lane or the like may be displayed in a region ranging b/3 from the lower edge of the mirror surface 44, and the sky over the road may be displayed in the other region. Further, a desirable visibility range in a camera monitoring system described in “Handbook of Camera Monitor Systems, The Automotive Mirror-Replacement Technology based on ISO 16505, Editors: Terzis, Anestis (Ed.)” may be employed.

Described next is how the direction of the electrical mirror 42L changes when the own vehicle makes a left turn at an intersection. FIG. 7 shows the direction of the electrical mirror 42L determined when the own vehicle A makes a left turn at the intersection from an inner entry lane L1 toward an inner exit lane R1 relative to a cornering direction. There are right-hand driving roads and left-hand driving roads in different countries, and the present invention is applicable to both types of roads. In this description, a left-hand driving road is described as an example. The present invention becomes applicable to a right-hand driving road by replacing the left in the following description with the right and replacing the right in the following description with the left.

In making a left turn at the intersection, a driver should take care in order for a motorcycle C in the left rear of the own vehicle A not to get caught in the own vehicle A. Of entry lanes L1, L2, and L3 for entry into the intersection, the entry lanes L1 and L2 are lanes allowing making of a left turn at the intersection. A plurality of lanes such as the entry lanes L1 and L2 allowing course change to the same direction at an intersection will be called same traveling direction entry lanes.

The geometry recognition unit 11 acquires course restriction information such as a course restriction mark in a lane from the image recognition device 31, recognizes a traveling direction along each of the entry lanes L1, L2, and L3 on the basis of the acquired course restriction information, and determines the presence or absence of same traveling direction entry lanes.

In FIG. 7, the position of the own vehicle A and the position of the motorcycle C at time tn are defined as P(tn) and Q(tn) respectively. For the convenience of description, n is set as follows: n=0, 1, 2, 3. However, the number of n can be increased further.

The own vehicle A has not entered the intersection at time t0, makes a left turn from time t1 to time t2, and has exited the intersection at time t3. The direction of the electrical mirror 42L is suited to the reference visibility direction 50L at the time t0 and the time t3. Namely, in coincidence with this timing, a driver can visually recognize the reference visibility direction 50L through the electrical mirror 42L.

At the time t1 and the time t2, the direction of the electrical mirror 42L is suited to a recommended visibility direction 51L. Namely, in coincidence with this timing, the driver can visually recognize the recommended visibility direction 51L through the electrical mirror 42L.

At the time t1, the visibility direction setting unit 13 sets a recommended visibility point X using a left-rear corner of the intersection as a starting point, and determines a direction in which the recommended visibility point X is seen from the own vehicle A to be the recommended visibility direction 51L.

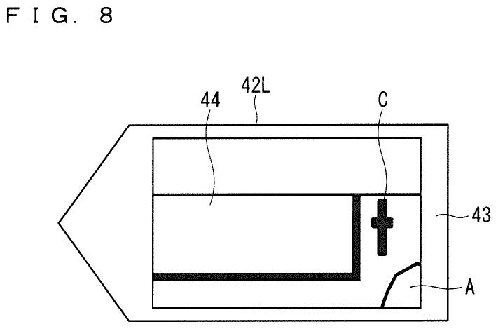

FIG. 8 shows a reflection displayed in the electrical mirror 42L at a point P(t1) or a point P(t2) in FIG. 7. The motorcycle C driving in the left rear of the own vehicle A is displayed in the mirror surface 44 of the electrical mirror 42L.

The visibility direction setting unit 13 may change the recommended visibility point X in response to whether the own vehicle A is to move to the inner exit lane R1 or to an outer exit lane R2 relative to a cornering direction. For example, when the own vehicle A is to move to the outer exit lane R2, the visibility direction setting unit 13 may change the recommended visibility point X to a higher position in the drawing than the position indicated in FIG. 7.

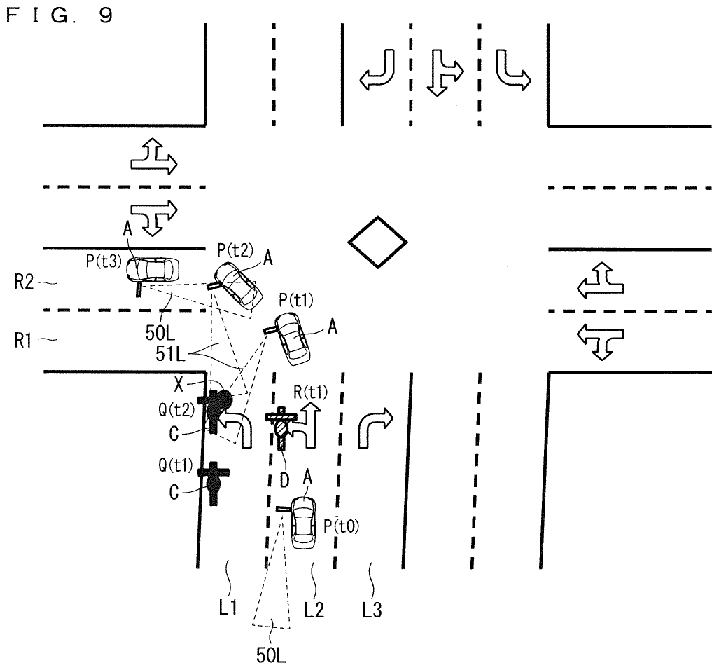

A comparative example will be described to show inconvenience occurring in a conventional method. FIG. 9 shows the direction of the electrical mirror 42L according to the comparative example determined when the own vehicle A makes a left turn at the intersection from the outer entry lane L2 toward the outer exit lane R2 relative to a cornering direction. In FIG. 9, the position of the own vehicle A and the position of the motorcycle C at the time tn are also defined as P(tn) and Q(tn) respectively. However, these positions are not the same as the positions P(tn) and Q(tn) in FIG. 7.

The own vehicle A has not entered the intersection at time t0, makes a left turn from time t1 to time t2, and has exited the intersection at time t3. The direction of the electrical mirror 42L is suited to the reference visibility direction 50L at the time t0 and the time t3. Namely, in coincidence with this timing, a driver can visually recognize the reference visibility direction 50L through the electrical mirror 42L.

When the own vehicle makes a left turn, the driver should take care in order for a motorcycle or a bicycle driving on the left of an own lane, or a bicycle driving on a sidewalk or a pedestrian on the sidewalk not to get caught in the own vehicle. Thus, the driver is required to visually recognize the following two regions. 1) If the position of the own vehicle A at the intersection is on an extension of a lane having been used by the own vehicle A for entering the intersection, a region in the presence of a moving object in the rear and driving in the same lane. 2) If the position of the own vehicle A at the intersection is on an extension of a same direction entry direction lane other than a lane having been used by the own vehicle A for entering the intersection, a region in the presence of a moving object in the rear and driving in this same direction entry lane.

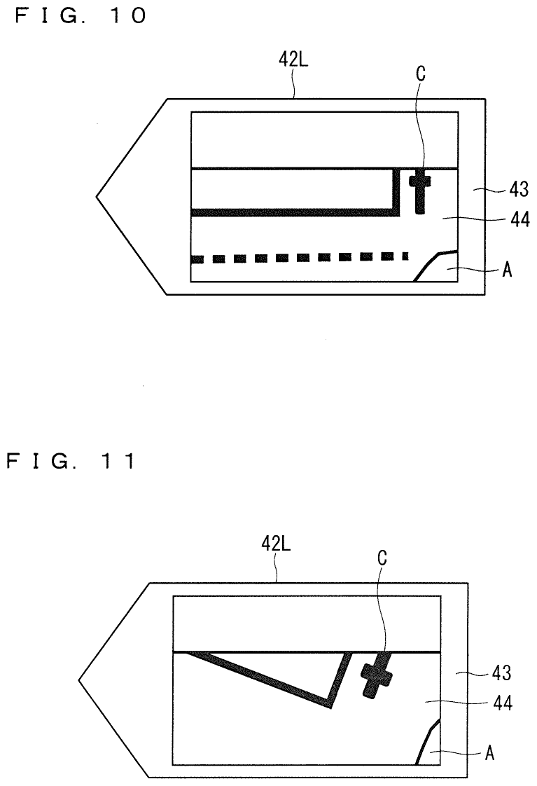

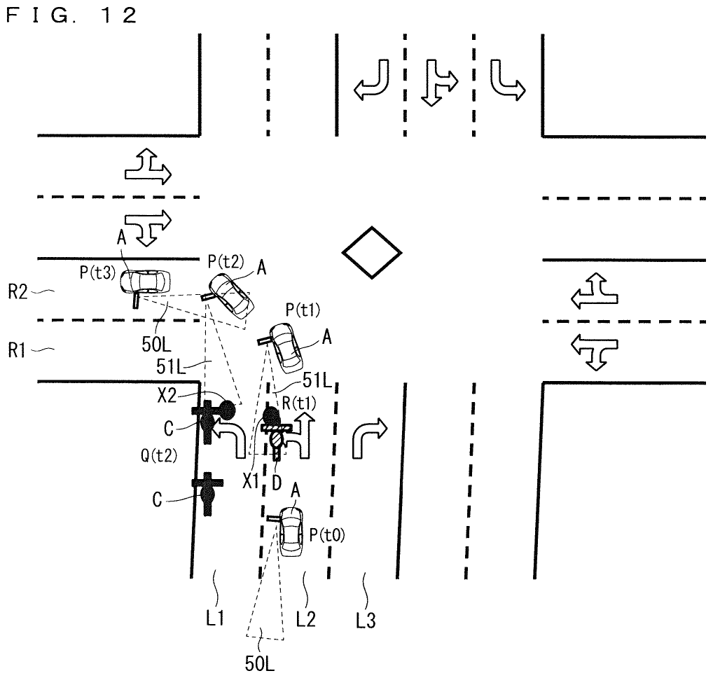

According to the comparative example, like in the case of FIG. 7, the recommended visibility point X at the time t1 and the time t2 is set using a left-rear corner of the intersection as a starting point, and the direction of the electrical mirror 42L is adjusted to a direction allowing visual recognition of the recommended visibility point X, As shown in FIG. 10, at the time t1, the motorcycle C driving at a position Q(t1) is displayed in the electrical mirror 42L. However, a motorcycle D driving in the rear of the own vehicle A in the entry lane L2 is not displayed in the electrical mirror 42L. As shown in FIG. 11, at the time t2, the motorcycle C driving at a position Q(t2) is displayed in the electrical mirror 42L. Hence, the method of setting the recommended visibility point X using a corner of the intersection as a starting point fails to set a region requiring visual recognition by the driver as the recommended visibility direction 51L while the driver is at P(t1) of FIG. 9.

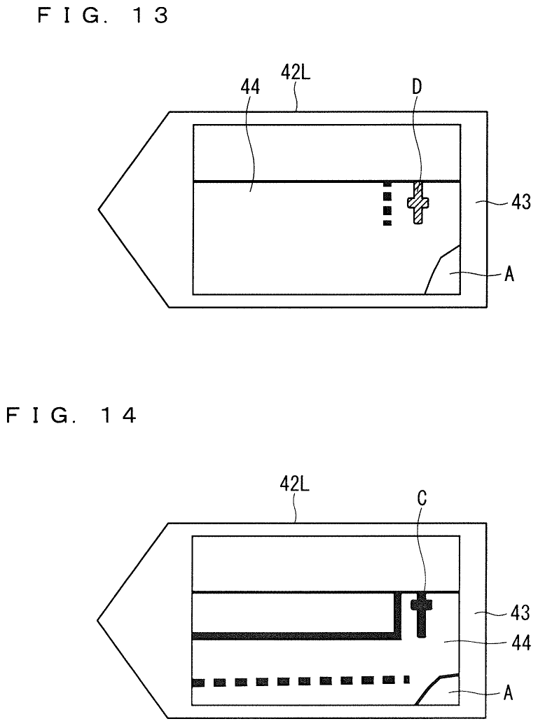

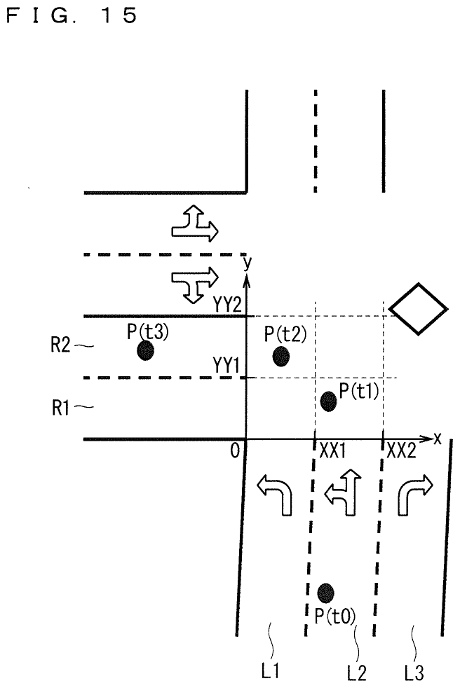

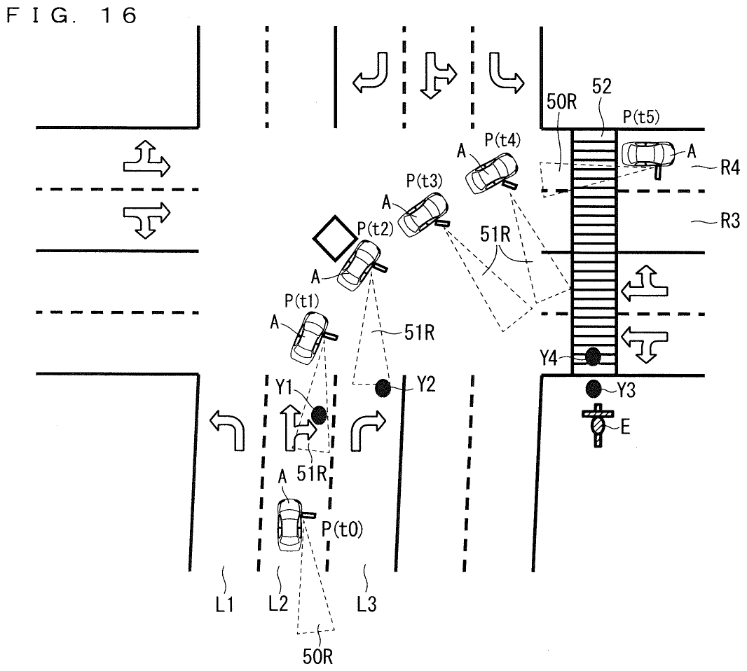

FIG. 12 shows the direction of the electrical mirror 42L according to the second embodiment determined under the same driving condition as that of FIG. 9. In the second embodiment, the visibility direction setting unit 13 sets a recommended visibility point X1 corresponding to P(t1) on the entry lane L2, and sets a recommended visibility point X2 corresponding to P(t2) on the entry lane L1. As shown in FIG. 13, the motorcycle D driving at a position R(t1) is displayed in the electrical mirror 42L at the time t1. As shown in FIG. 14, the motorcycle C driving at the position Q(t2) is displayed in the electrical mirror 42L at the time t2. In this way, a recommended visibility point is changed dynamically in response to the position of an extension of each of same direction entry lanes and that of the own vehicle, so that a region requiring visual recognition by the driver can always be set as the recommended visibility direction 51L.

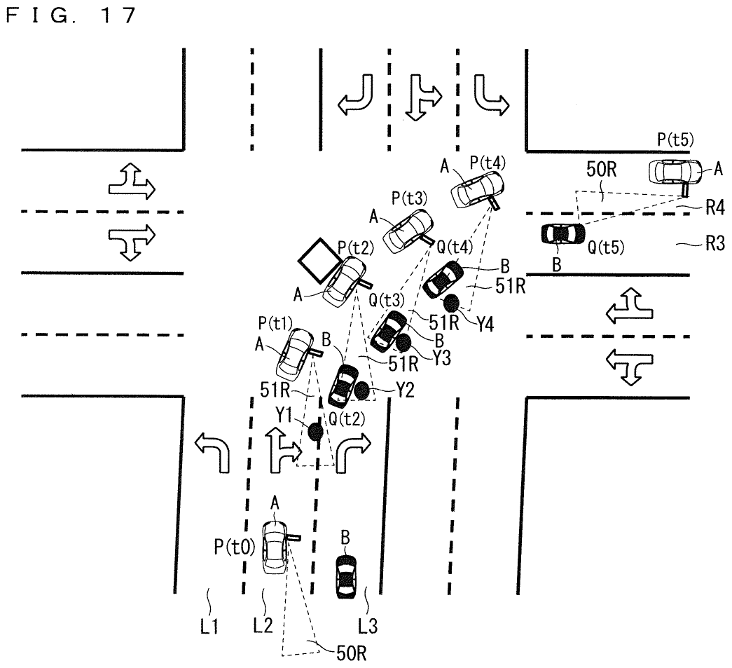

FIG. 15 shows the details of a method of setting the recommended visibility points X1 and X2 shown in FIG. 12.

The position P(t) of the own vehicle A at the time t is expressed as P(pxt, pyt) in an xy coordinate system. The x axis is a direction in which the exit lanes R1 and R2 extend to the intersection. The y axis is a direction in which the entry lanes L1, L2, and L3 extend to the intersection. The origin is set at a corner on the left near side of the intersection. The x coordinate of a boundary between the entry lanes L1 and L2 is defined as XX1. The x coordinate of a boundary between the entry lanes L2 and L3 is defined as XX2. Further, a recommended visibility point X(t) at the time t is expressed as X(xxt, yyt) in the same coordinate system.

If pyt<0, the own vehicle A is in a stage before entry into the intersection. The visibility direction setting unit 13 suits the direction of the electrical mirror 42L to the reference visibility direction 50L.

If pyt≥0 and XX1≤pxt<XX2, the own vehicle A is in the intersection and on an extension of the entry lane L2 having been used by the own vehicle A for entering the intersection. In this case, the visibility direction setting unit 13 sets the coordinates of the recommended visibility point X as (XX1+Lx, Ly). For example, Lx is 0.5 m and Ly is −5 m. Then, the visibility direction setting unit 13 sets a direction in which the recommended visibility point X is seen from the own vehicle A as the recommended visibility direction 51L in response to an angle of cornering of the own vehicle A.

If pyt≥0 and 0≤pxt<XX1, the own vehicle A is in the intersection and on an extension of a same direction entry direction lane other than the entry lane L2 having been used by the own vehicle A for entering the intersection. In this case, the visibility direction setting unit 13 sets the coordinates of the recommended visibility point X as (Lx, Ly). Then, the visibility direction setting unit 13 sets a direction in which the recommended visibility point X is seen from the own vehicle A as the recommended visibility direction 51L in response to an angle of cornering of the own vehicle A.

If pxt<0, the own vehicle A has exited the intersection. In this case, the visibility direction setting unit 13 suits the direction of the electrical mirror 42L to the reference visibility direction 50L.

The direction of the electrical mirror 42L determined in the case of making a left turn at the intersection has been described by referring to FIGS. 7 to 15. As for the electrical mirror 42R, the direction thereof is set at the reference visibility direction 50R.

If the own vehicle A has entered the intersection, namely, if pyt≥0, the position of the recommended visibility point X can be determined in the ways given in the following modifications independently of the value of pxt. For example, the visibility direction setting unit 13 may set the recommended visibility point X just in the rear of the own vehicle A. In this case, the coordinates of the recommended visibility point X are defined as (pxt, Ly). Being just in the rear of the own vehicle A can be replaced with being a direction just in the rear of the position of a target electrical mirror as a base point.

Alternatively, in consideration of the move of the own vehicle A to the left, the visibility direction setting unit 13 may set the recommended visibility point X not just in the rear of the own vehicle A but may be set slightly leftward. In this case, the coordinates of the recommended visibility point X are defined as (pxt−Lx1, Ly).

Further, the visibility direction setting unit 13 may set the recommended visibility point X in the rear of the own vehicle A separated by Ly2. For example, Ly2 is 5 m. In this case, the coordinates of the recommended visibility point X are defined as (pxt−Lx1, Ly−Ly2).

Further, the visibility direction setting unit 13 may set the recommended visibility point X in a stage before entry of the own vehicle A into the intersection. More specifically, if Ly≤Pyt<0, the visibility direction setting unit 13 sets the coordinates of the recommended visibility point X as (XX1+Lx, xyt=xpt+Ly).

If the own vehicle A is driving by following routing assistance provided by a car navigation system, the visibility direction setting unit 13 can predict a right or left turn by the own vehicle A before entry into an intersection by acquiring routing assistance information from the car navigation system.

If the own vehicle A is under self-driving control by a self-driving controller according to a vehicle driving control plan, the visibility direction setting unit 13 can predict a right or left turn by the own vehicle A before entry into an intersection by acquiring self-driving control information from the self-driving controller.

Two recommended visibility points X1 and X2 have been described by referring to FIG. 12. The recommended visibility point may be changed continuously or discontinuously from X1 to X2 in response to the position of the own vehicle A.

Described next is how the direction of the electrical mirror 42R changes when the own vehicle A makes a right turn at the intersection. When the own vehicle A makes a right turn at the intersection, a driver should take care so as to avoid contact with a different vehicle such as a motorcycle driving on the right of an own lane, or with a motorcycle, a bicycle, and a pedestrian moving forward from the right rear of an oncoming lane.

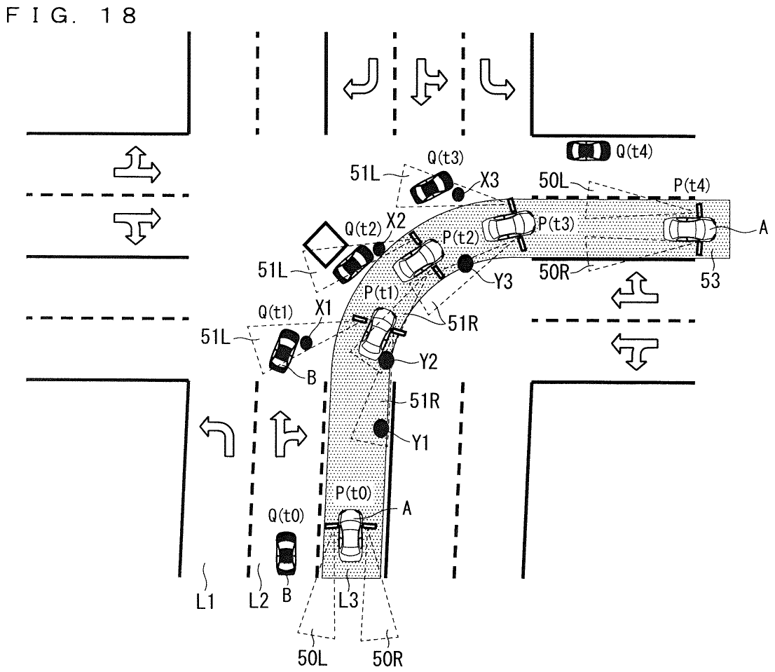

FIG. 16 shows the direction of the electrical mirror 42L determined when the own vehicle A makes a right turn at the intersection from the outer entry lane L2 toward an outer exit lane R4 relative to a cornering direction. It is assumed that, after the own vehicle A makes a right turn at the intersection, the own vehicle A sees a pedestrian crossing 52 ahead of the own vehicle A and a bicycle E or pedestrians can move on the pedestrian crossing 52. In FIG. 16, a consecutive path of the own vehicle A in making a right turn at the intersection is expressed by the position P(tn) of the own vehicle A at the time tn. The own vehicle A drives in the entry lane L2 in front of the intersection at time t0, enters the intersection from time t1 to time t4, and exits the intersection at time t5.

At the time t0 and the time t5, the electrical mirror 42R is adjusted to the reference visibility direction 50R.

In a period from the time t1 to the time t3, the electrical mirror 42R is adjusted to a recommended visibility direction 51R. The recommended visibility direction 51R is a direction in which a recommended visibility point is seen from the own vehicle A.

At the time t1, the own vehicle A is in the intersection and driving on an extension of the entry lane L2. At this time, a recommended visibility point Y1 is set at the right edge of the entry lane L2. At the time t2, the own vehicle A is in the intersection and driving on an extension of the entry lane L3. The entry lane L3 is a same direction entry lane corresponding to the entry lane L2. At this time, a recommended visibility point Y2 is set at the right edge of the entry lane L3.

At the time 3, the own vehicle A is in the intersection, has passed the extension of the entry lane L3, and is approaching the exit lane R4. At the time t4, the own vehicle A is getting closer to the exit lane R4. A recommended visibility point Y3 at the time t3 is set on or in the rear of the pedestrian crossing 52. A recommended visibility point Y4 at the time t4 is also set in the rear of the pedestrian crossing 52. However, in consideration of the position of the driving own vehicle A closer to the pedestrian crossing 52, the recommended visibility point Y4 is set ahead of the recommended visibility point Y3, namely, closer to the exit lane R4 than the recommended visibility point Y3.

### Effects of Second Embodiment

In the side and rear reflection controller 102 of the second embodiment, the visibility direction setting unit 13 sets a particular direction from the side and rear of the own vehicle A and based on the own vehicle A as the reference visibility direction 50R or 50L, and the mirror control unit 14A controls the side and rear reflection display device 22 so as to make a switch of a presentation to a driver between a reflection in the recommended visibility direction 51L or 51R and a reflection in the reference visibility direction. This allows the driver to visually recognize the reflection in the recommended visibility direction 51L or 51R and the reflection in the reference visibility direction 50L or 50R.

In the side and rear reflection controller 102 of the second embodiment, the geometry recognition unit 11 recognizes the geometry of an intersection on the basis of a captured image of a periphery of the own vehicle A. This allows the side and rear reflection controller 102 to recognize the geometry of the intersection correctly on the basis of the captured image, and then set the recommended visibility direction 51L or 51R properly.

The side and rear reflection display device 22 of the second embodiment includes the electrical mirrors 42L and 42R of the own vehicle A. The mirror control unit 14A controls the directions of the electrical mirrors 42L and 42R. This allows the driver to visually recognize reflections in the recommended visibility directions 51L and 51R using the electrical mirrors 42L and 42R respectively.

In the side and rear reflection display device 22 of the second embodiment, the geometry recognition unit 11 recognizes the geometries of same direction entry lanes, the position recognition unit 12 grasps the position of the own vehicle A relative to extensions of the same direction entry lanes to the intersection on the basis of the geometries of the same direction entry lanes, and the visibility direction setting unit 13 sets each of the recommended visibility directions 51L and 51R on the basis of the position of the own vehicle A relative to the extensions of the same direction entry lanes to the intersection. This allows the side and rear reflection display device 22 to set each of the recommended visibility directions 51L and 51R properly so as to follow a direction requiring visual recognition by the driver and to be changed in response to the position of the own vehicle A in the intersection.

In the side and rear reflection display device 22 of the second embodiment, the position recognition unit 12 grasps the direction of the own vehicle A relative to the intersection on the basis of the geometry of the intersection, and the visibility direction setting unit 13 sets each of the recommended visibility directions 51L and 51R on the basis of the direction of the own vehicle A relative to the intersection. This allows the side and rear reflection display device 22 to set a direction in which the driver sees a point requiring visual recognition from the own vehicle A as each of the recommended visibility directions 51L and 51R.

### Third Embodiment

The side and rear reflection controller 102 of the second embodiment sets a recommended visibility direction on the assumption that a pedestrian crossing exits ahead of a destination of a right turn of the own vehicle A. By contrast, a side and rear reflection controller 103 of a third embodiment recognizes the presence or absence of a pedestrian crossing ahead of a destination of a right turn, and then sets a recommended visibility direction on the basis of the presence or absence of the pedestrian crossing.

A side and rear reflection display system of the third embodiment includes the side and rear reflection controller 103, a side and rear reflection display device 23, and the image recognition device 31, and have the same configuration as that of the second embodiment shown in FIG. 3.

The geometry recognition unit 11 of the third embodiment has the function of detecting the presence or absence of a pedestrian crossing in a course changing direction in an intersection using image recognition information from the image recognition device 31, in addition to the function described in the second embodiment.

If the geometry recognition unit 11 detects a pedestrian crossing in the course changing direction in the intersection, the visibility direction setting unit 13 and the mirror control unit 14A operate in the same way as the way described in the second embodiment by referring to FIG. 16.

The following describes the directions of the electrical mirrors 42L and 42R determined when the geometry recognition unit 11 detects the absence of a pedestrian crossing in the course changing direction in the intersection.

FIG. 17 shows the direction of the electrical mirror 42R determined when the own vehicle A makes a right turn at the intersection from the outer entry lane L2 toward the outer exit lane R4 relative to a cornering direction. As there is no pedestrian crossing ahead of a destination of a right turn, a pedestrian or a bicycle is not to cross an exit lane R3 or R4.

In FIG. 17, a driving path of the own vehicle A is expressed by the position P(tn) at the time tn.

At time t0 and time t5, the own vehicle A is not in the intersection and the electrical mirror 42R is adjusted to the reference visibility direction 50R. In a period from time t1 to time t4, the electrical mirror 42R is adjusted to the recommended visibility direction 51L.

At the time t1, the own vehicle A is in the intersection and driving on an extension of the entry lane L2. At this time, a recommended visibility point Y1 is set at the right edge of the entry lane L2. At the time t2, the own vehicle A is in the intersection and driving on an extension of the entry lane L3. The entry lane L3 is a same direction entry lane corresponding to the entry lane L2. At this time, a recommended visibility point Y2 is set at the right edge of the entry lane L3.

At the time t3, the own vehicle A is in the intersection, has passed the extension of the entry lane L3, and is approaching the exit lane R4. At the time t4, the own vehicle A is getting closer to the exit lane R4. At the time t3 and the time t4, the visibility direction setting unit 13 sets a recommended visibility direction so as to allow visual recognition of a different vehicle B driving inside the own vehicle A. In this regard, the visibility direction setting unit 13 does not actually detect the position of the different vehicle B. The visibility direction setting unit 13 estimates a driving path of the different vehicle B, and then sets recommended visibility points Y3 and Y4 along the estimated driving path of the different vehicle B on the basis of the position P(tn) of the own vehicle A.

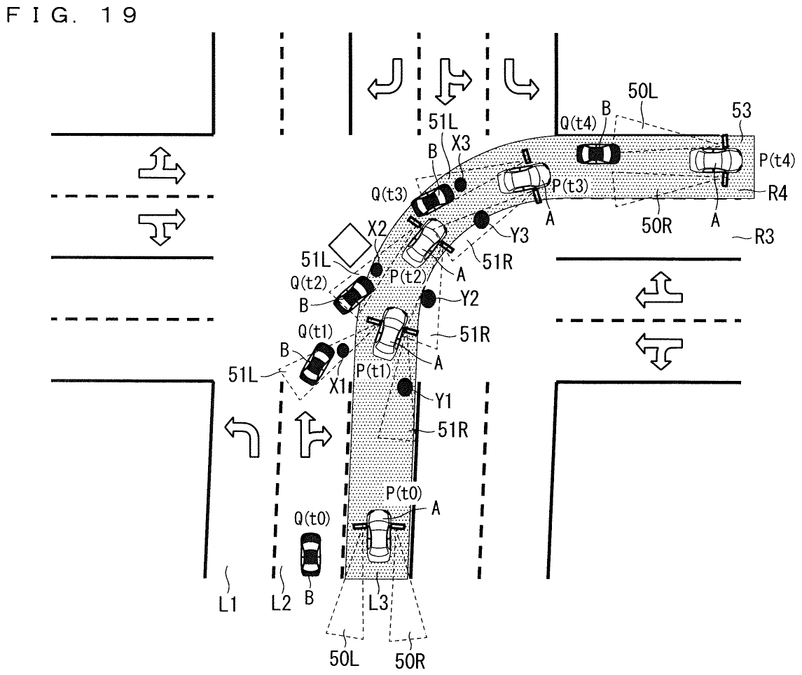

FIG. 18 shows the directions of the electrical mirrors 42L and 42R determined when the own vehicle A makes a right turn at the intersection from the inner entry lane L3 toward the inner exit lane R3 relative to a cornering direction. It is likely that the different vehicle B will make a right turn from outside the own vehicle A from the entry lane L2 toward the exit lane R4. In FIG. 18, a driving path of the own vehicle A is expressed by the position P(tn) at the time tn, a recommended visibility point on the left rear of the own vehicle A at the time tn is expressed as Xn, and a recommended visibility point on the right rear of the own vehicle A at the time tn is expressed as Yn.

At time t0 and time t4, the own vehicle A is not in the intersection. The electrical mirrors 42L and 42R are adjusted to the reference visibility directions 50L and 50R respectively at these times. At time t1, time t2, and time t3, the electrical mirror 42R is adjusted to the recommended visibility direction 51L. The recommended visibility direction 51L is set at a direction allowing visual recognition of the different vehicle B from the own vehicle A. More specifically, the visibility direction setting unit 13 sets each of recommended visibility points X1, X2, and X3 in a direction allowing visual recognition of the different vehicle B from the own vehicle A, and sets a direction in which each of the recommended visibility points X1, X2, and X3 is seen from the own vehicle A as the recommended visibility direction 51L. The recommended visibility points X1, X2, and X3 are set on the basis of a driving path of the different vehicle B and a driving path of the own vehicle A.

The electrical mirror 42L is adjusted to the recommended visibility direction 51R at the times t1, t2, and t3. The recommended visibility direction 51R is set at a direction allowing visual recognition of a different vehicle likely to overtake the own vehicle A from inside the own vehicle A (hereinafter called an “overtaking vehicle”). As there is no same direction entry lane inside an own lane in the case of FIG. 18, an overtaking vehicle is a motorcycle, for example. More specifically, the visibility direction setting unit 13 sets each of recommended visibility points Y1, Y2, and Y3 in a direction allowing visual recognition of the overtaking vehicle from the own vehicle A, and sets a direction in which each of the recommended visibility points Y1, Y2, and Y3 is seen from the own vehicle A as the recommended visibility direction 51R. The recommended visibility points Y1, Y2, and Y3 are set on the basis of a driving path of the overtaking vehicle and a driving path of the own vehicle A. If there is a same direction entry lane inside the own lane, a four-wheel vehicle may also be an overtaking vehicle. In this regard, the recommended visibility direction is set so as to allow visual recognition of a part of the rear of the inner lane.

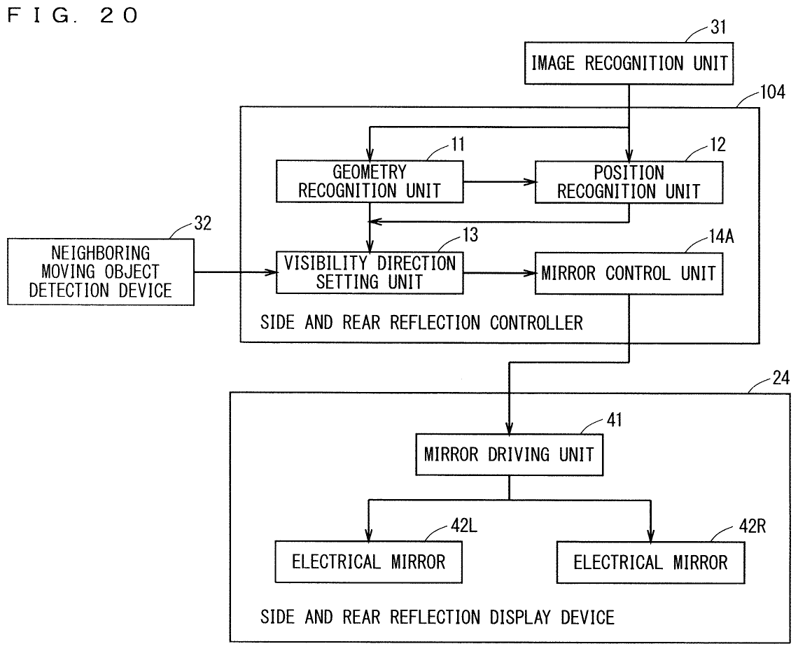

FIG. 19 shows the directions of the electrical mirrors 42L and 42R determined when the own vehicle A makes a right turn at the intersection from the inner entry lane L3 toward the outer exit lane R4 relative to a cornering direction. It is likely that the different vehicle B will make a right turn from outside the own vehicle A from the entry lane L2 toward the exit lane R4. In FIG. 19, a driving path of the own vehicle A is expressed by the position P(tn) at the time tn, a recommended visibility point on the left rear of the own vehicle A at the time tn is expressed as Xn, and a recommended visibility point on the right rear of the own vehicle A at the time tn is expressed as Yn. The description of a method of setting the directions of the electrical mirrors 42L and 42R in the case of FIG. 19 will be omitted as it is the same as the method described by referring to FIG. 18.

The directions of the electrical mirrors 42L and 42R determined in making a right turn have been described by referring to FIGS. 17 to 19. When the own vehicle A makes a left turn, the visibility direction setting unit 13 also changes a recommended visibility direction in response to the presence or absence of a pedestrian crossing ahead of a destination of the left turn. For example, in the illustration of FIG. 12, the recommended visibility point X2 is set at the left edge of the entry lane L1. In the second embodiment, the recommended visibility point X2 is set at this position in the absence of a pedestrian crossing ahead of a destination of the left turn. In the presence of a pedestrian crossing ahead of a destination of the left turn, the recommended visibility point is set at a position on the left of the left edge of the entry lane L1.

### Effects of Third Embodiment

In the side and rear reflection controller 103 of the third embodiment, the geometry recognition unit 11 recognizes the presence or absence of a pedestrian crossing on an exit lane from the intersection, and the visibility direction setting unit 13 sets a recommended visibility direction on the basis of the presence or absence of the pedestrian crossing. Thus, the side and rear reflection controller 103 allows a driver to visually recognize a proper recommended visibility direction responsive to the presence or absence of a pedestrian crossing.

### Fourth Embodiment

In the third embodiment, a driving path of a vehicle having entered the intersection from a next lane and changing a course to the same direction is predicted, and a recommended visibility point is selected from points on the predicted driving path. By contrast, according to a fourth embodiment, the position of the different vehicle B in the side and rear of the own vehicle A and traveling in a same direction entry lane is actually detected, and a recommended visibility direction is set so as to allow visual recognition of the detected position of the different vehicle B.

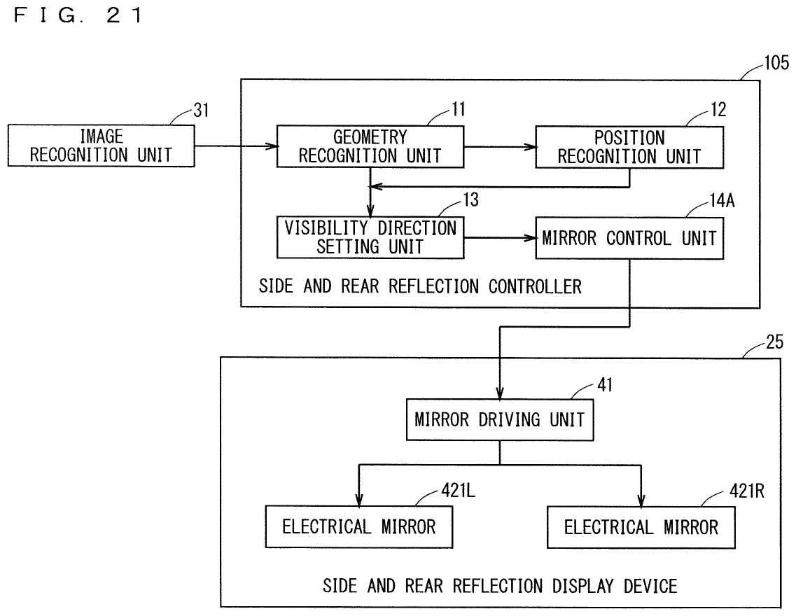

FIG. 20 is a block diagram showing the configuration of a side and rear reflection display system according to the fourth embodiment. A structure equal to or corresponding to that in the other embodiments is given the same sign in FIG. 20. The side and rear reflection display system of the fourth embodiment includes a side and rear reflection controller 104, a side and rear reflection display device 24, the image recognition device 31, and a neighboring moving object detection device 32.

The neighboring moving object detection device 32 is configured using a laser radar, a millimeter-wave radar, an image processing sensor, an ultrasonic sensor, or a different type of sensor. The neighboring moving object detection device 32 detects the presence or absence of a moving object in a neighborhood of the own vehicle A, the position of the neighboring moving object relative to the own vehicle A, or change in the relative position.

The visibility direction setting unit 13 acquires a result of the detection by the neighboring moving object detection device 32, and sets a recommended visibility direction so as to allow visual recognition of the position of the different vehicle B on the basis of the acquired detection result.

According to the second embodiment, the direction of the electrical mirror 42L or 42R is adjusted to a recommended visibility direction in making entry into an intersection as shown in FIGS. 7 and 12, for example. By contrast, according to the fourth embodiment, if a moving object is not detected in the rear of the own vehicle A in the situations shown in FIGS. 7 and 12, the direction of the electrical mirror 42L or 42R is maintained at a reference visibility direction even in making entry into the intersection as well as in driving in a place other than the intersection.

If the presence of the different vehicle B driving inside the own vehicle A is detected in the situation shown in FIG. 16, the direction of the electrical mirror 42L or 42R may be adjusted to a direction allowing visual recognition of the different vehicle B, as shown in FIG. 17. According to the third embodiment, a recommended visibility direction is set by estimating a driving path of the different vehicle B driving inside or outside the own vehicle A. By contrast, according to the fourth embodiment, the position and direction of the different vehicle B relative to the own vehicle A can actually be detected by the neighboring moving object detection device 32. As a result, when the own vehicle A enters an intersection and changes a course, a recommended visibility direction can be set correctly that allows visual recognition of a different vehicle driving in the rear of the own vehicle A or driving inside or outside the own vehicle A at the time of cornering motion for the course change.

If the neighboring moving object detection device 32 detects a moving object in the rear of the own vehicle A, the visibility direction setting unit 13 may change a recommended visibility point in response to a distance to the rear moving object. For example, the visibility direction setting unit 13 makes a distance between the own vehicle A and the recommended visibility point longer as a distance between the own vehicle A and the rear moving object becomes longer.

If the neighboring moving object detection device 32 is capable of detecting a difference in speed between the own vehicle A and the rear moving object, the visibility direction setting unit 13 may set a recommended visibility point in response to the difference in speed. For example, if the rear moving object is approaching the own vehicle A, the visibility direction setting unit 13 sets a recommended visibility point at a closer position to the own vehicle A than a position determined when the rear moving object is getting away from the own vehicle A.

### Effects of Fourth Embodiment

In the side and rear reflection controller 104 of the fourth embodiment, the visibility direction setting unit 13 sets a recommended visibility direction on the basis of position information about a moving object driving in a neighborhood of the own vehicle A. This allows a driver to visually recognize a proper recommended visibility direction responsive to the position of the moving object driving in the neighborhood of the own vehicle A.

### Fifth Embodiment

FIG. 21 is a block diagram showing the configuration of a side and rear reflection display system according to a fifth embodiment. A structure equal to or corresponding to that in the other embodiments is given the same sign in FIG. 21. The side and rear reflection display system of the fifth embodiment includes a side and rear reflection controller 105, a side and rear reflection display device 25, and the image recognition device 31. The side and rear reflection controller 105 has the same configuration as the side and rear reflection controller 102 of the second embodiment. The side and rear reflection display device 25 includes an electrical mirror 421L and an electrical mirror 421R instead of the electrical mirrors 42L and 42R respectively in the side and rear reflection display device 22 of the second embodiment.

Each of the electrical mirrors 42L and 42R of the second embodiment has one mirror surface 44, and one of a reference visibility direction and a recommended visibility direction is displayed in the mirror surface 44. By contrast, each of the electrical mirrors 421L and 421R of the fifth embodiment has two mirror surfaces, and both a reference visibility direction and a recommended visibility direction are presented simultaneously to a driver.

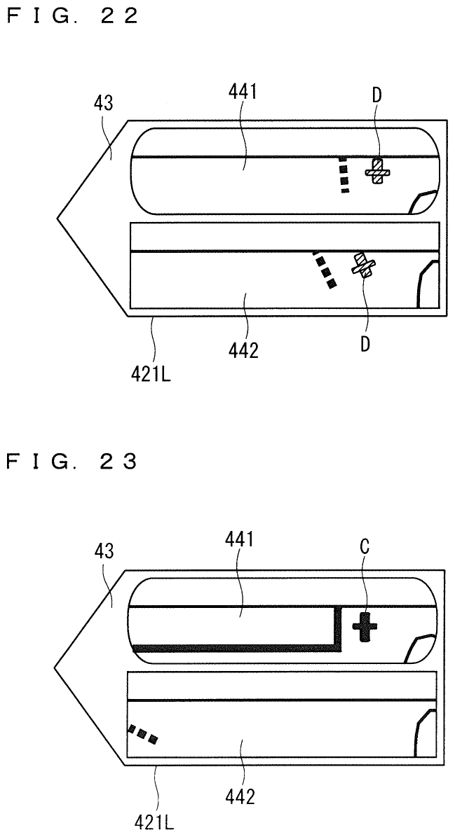

FIGS. 22 and 23 each show the electrical mirror 421L of the fifth embodiment. The electrical mirror 421L has a first mirror surface 441 and a second mirror surface 442. A reflection in a recommended visibility direction is displayed in the first mirror surface 441, and a reflection in a reference visibility direction is displayed in the second mirror surface 442. In other words, the first mirror surface 441 is a first region for display of a reflection in the recommended visibility direction, and the second mirror surface 442 is a second region for display of a reflection in the recommended visibility direction. As shown in these drawings, giving different shapes to the first mirror surface 441 and the second mirror surface 442 allows a driver to easily distinguish the properties of reflections displayed in the corresponding mirror surfaces from each other.

FIG. 22 shows a reflection displayed in the electrical mirror 421L at the point P(t1) in FIG. 12. FIG. 23 shows a reflection displayed in the electrical mirror 421L at the point P(t2) in FIG. 12.

With respect to a side surface of the own vehicle A, a recommended visibility direction is located outside a reference visibility direction. Thus, the first mirror surface 441 may be located outside the second mirror surface 442 to allow a driver to easily distinguish the properties of reflections displayed in the corresponding mirror surfaces from each other.

### Effects of Fifth Embodiment

The visibility direction setting unit 13 sets a particular direction from the side and rear of the own vehicle and based on the own vehicle as a reference visibility direction. The side and rear reflection display device has a display surface with the first mirror surface 441 as the first region and the second mirror surface 442 as the second region. The control unit 14 controls the side and rear reflection display device 25 so as to display a reflection in a recommended visibility direction in the first mirror surface 441 and display a reflection in the reference visibility direction in the second mirror surface 442. This allows a driver to visually recognize the recommended visibility direction and the reference visibility direction simultaneously.

### Sixth Embodiment

According to the second to fifth embodiments, an electrical mirror is used for making a driver visually recognize a recommended visibility direction. By contrast, according to a sixth embodiment, an electronic mirror is used for making a driver visually recognize a recommended visibility direction.

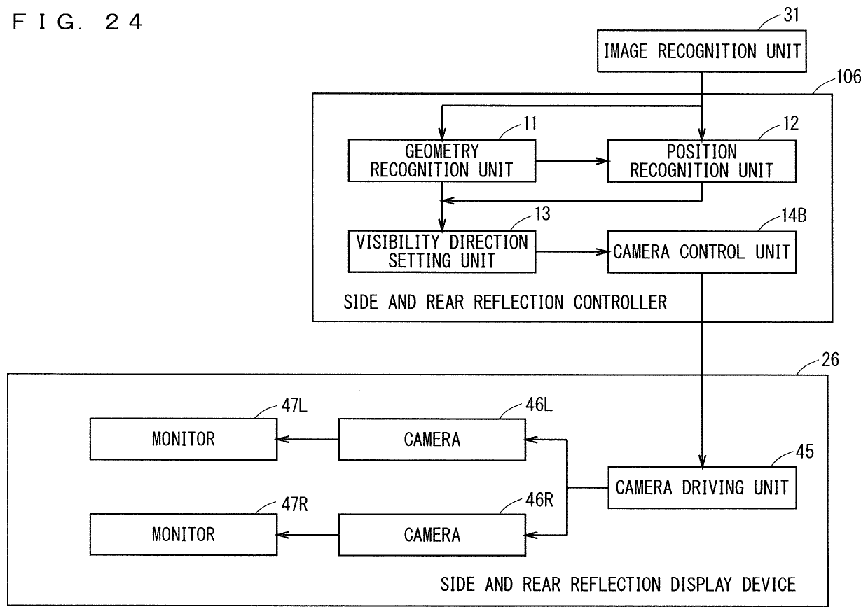

FIG. 24 is a block diagram showing the configuration of a side and rear reflection display system according to the sixth embodiment. The side and rear reflection display system of the sixth embodiment includes a side and rear reflection controller 106, a side and rear reflection display device 26, and the image recognition device 31. The side and rear reflection controller 106 includes a camera control unit 14B instead of the mirror control unit 14A in the side and rear reflection controller 102 of the second embodiment. A structure equal to or corresponding to that in the second embodiment is given the same sign in FIG. 24.

The camera control unit 14B controls a camera driving unit 45 of the side and rear reflection display device 26 so as to present a recommended visibility region or a reference visibility region to a driver.

The side and rear reflection display device 26 includes the camera driving unit 45, a camera 46L, a camera 46R, a monitor 47L, and a monitor 47R.

The camera 46L is attached to the front of the left door of the own vehicle A, for example, and used for capturing an image in a partial direction from the left side and rear of the own vehicle A. The camera 46R is attached to the front of the right door of the own vehicle A, for example, and used for capturing an image in a partial direction from the right side and rear of the own vehicle A. The directions of capturing by the cameras 46L and 46R are set by the camera control unit 14B and adjusted by the camera driving unit 45 under control by the camera control unit 14B.

The image captured by the camera 46L is displayed in the monitor 47L mounted on the own vehicle A. The image captured by the camera 46R is displayed in the monitor 47R mounted on the own vehicle A. Thus, suiting the direction of capturing by each of the cameras 46L and 46R to a recommended visibility direction allows a driver to visually recognize the recommended visibility direction through each of the monitors 47L and 47R.

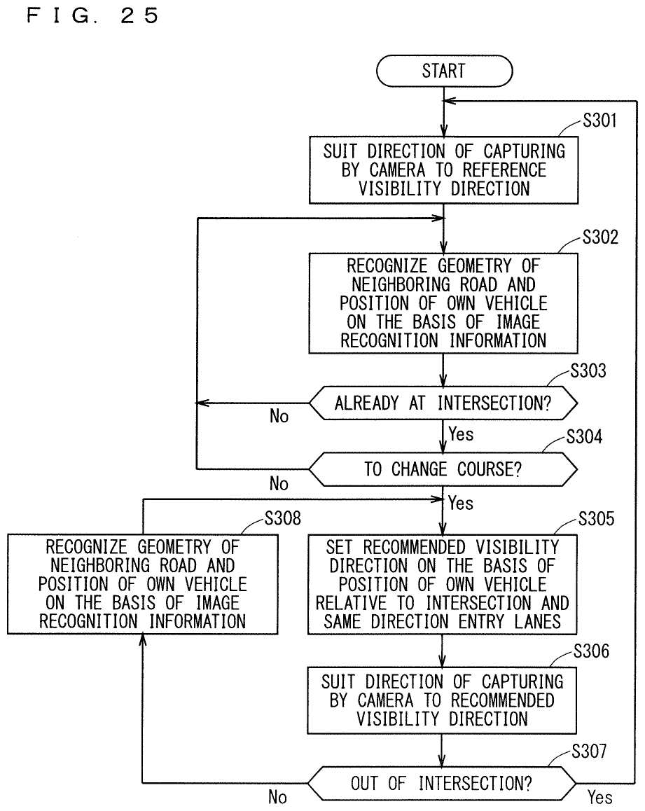

FIG. 25 is a flowchart showing the operation of the side and rear reflection display system according to the sixth embodiment. Steps S302 to S305, S307, and S308 in the flow of FIG. 25 are the same as steps S202 to S205, S207, and S208 respectively in the flow of the second embodiment shown in FIG. 4. The flow of FIG. 25 differs from the flow of FIG. 4 only in steps S301 and S306.

In step S301, the camera driving unit 45 suits a direction of capturing by each of the cameras 46L and 46R to a reference visibility direction under control by the camera control unit 14B.

In step S306, the camera driving unit 45 suits a direction of capturing by each of the cameras 46L and 46R to a recommended visibility direction under control by the camera control unit 14B.

### Modifications of Sixth Embodiment

As described above, an image captured by the camera 46L is displayed in the monitor 47L and an image captured by the camera 46R is displayed in the monitor 47R. In this way, one monitor is prepared for an image captured by a one-side camera. Alternatively, two monitors may be prepared for images captured by a one-side camera to display an image in a recommended visibility direction an image in a reference visibility direction.

Alternatively, a display region of one monitor may be divided vertically into two to display an image in a recommended visibility direction and an image in a reference visibility direction. In this case, if the own vehicle A does not change a course at an intersection, both the display regions of the monitor may be allocated to display of the image in the reference visibility direction. The image in the recommended visibility direction and the image in the reference visibility direction may be displayed only when the own vehicle A changes a course at the intersection.

### Effects of Sixth Embodiment

The side and rear reflection display device 26 includes the cameras 46L and 46R as capturing devices for capturing images of the side and rear of the own vehicle A, and the monitors 47L and 47R mounted on the own vehicle A for display of the images captured by the capturing devices. This allows a driver to visually recognize recommended visibility directions through the monitors 47L and 47R.

The camera control unit 14B controls directions of capturing by the cameras 46L and 46R. This allows a driver to visually recognize recommended visibility directions through the monitors 47L and 47R.

### Seventh Embodiment

According to the sixth embodiment, directions of capturing by the cameras 46L and 46R are adjusted to be suited to recommended visibility directions. By contrast, according to a seventh embodiment, an image of the side and rear of the own vehicle A is captured using a wide-angle camera available for capturing a range wider than a recommended visibility direction, and the captured image is trimmed so as to conform to the recommended visibility direction.

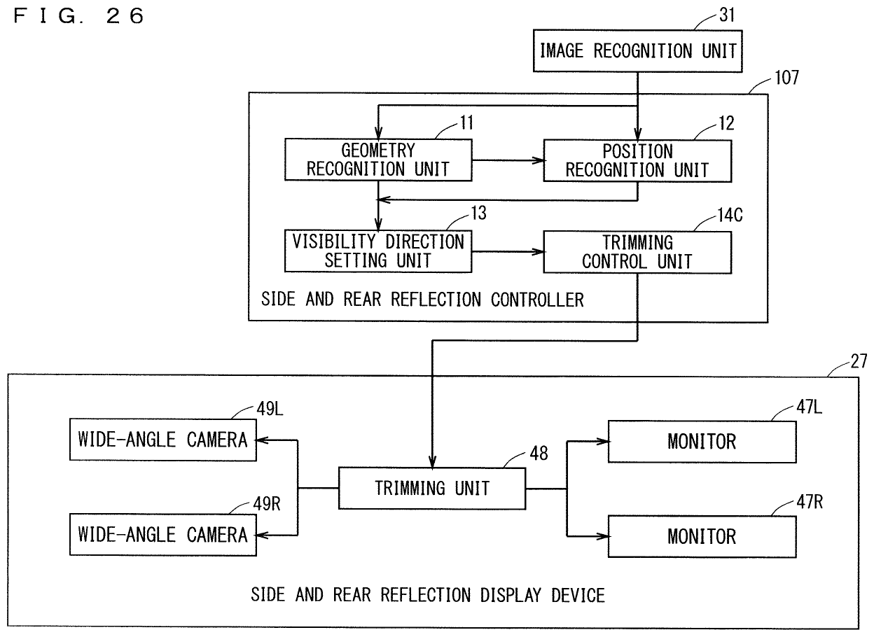

FIG. 26 is a block diagram showing the configuration of a side and rear reflection display system according to the seventh embodiment. The side and rear reflection display system of the seventh embodiment includes a side and rear reflection controller 107, a side and rear reflection display device 27, and the image recognition device 31. The side and rear reflection controller 107 includes a trimming control unit 14C instead of the camera control unit 14B in the configuration of the side and rear reflection controller 106 of the sixth embodiment. A structure equal to or corresponding to that in the other embodiments is given the same sign in FIG. 26.

The side and rear reflection display device 27 includes a wide-angle camera 49L, a wide-angle camera 49R, a trimming unit 48, and the monitors 47L and 47R.

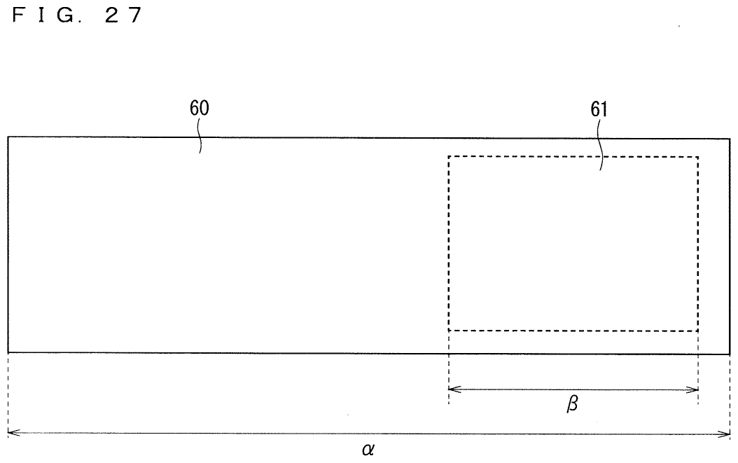

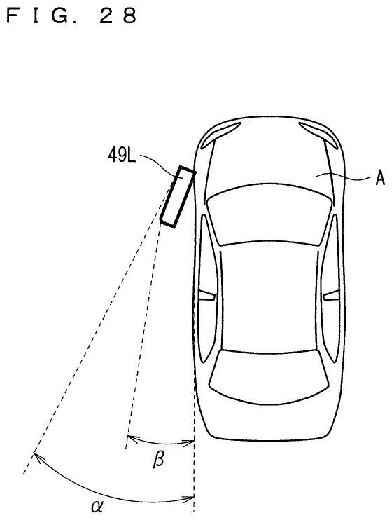

FIG. 27 shows a relationship between an image 60 captured by the wide-angle camera 49L and a range 61 of trimming by the trimming unit 48. The trimming range 61 is displayed in the monitors 47L and 47R.

FIG. 28 shows an angle of view α of the wide-angle camera 49L and an angle of view β of the trimming range 61. For example, α is 25° and β is 10°. While trimming of the image captured by the wide-angle camera 49L is described by referring to FIGS. 27 and 28, an image captured by the wide-angle camera 49R is trimmed in the same way.

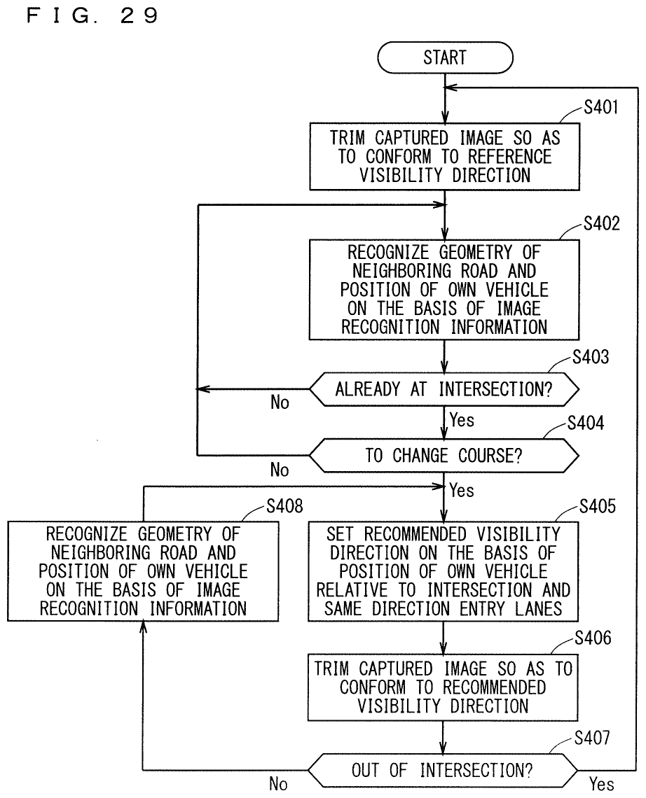

FIG. 29 is a flowchart showing the operation of the side and rear reflection display system according to the seventh embodiment. Steps S402 to S405, S407, and S408 in the flow of FIG. 29 are the same as steps S202 to S205, S207, and S208 respectively in the flow of the second embodiment shown in FIG. 4. The flow of FIG. 29 differs from the flow of FIG. 4 only in steps S401 and S406.

In step S401, the trimming unit 48 trims an image captured by each of the wide-angle camera 49L and the wide-angle camera 49R under control by the trimming control unit 14C so as to conform to a corresponding reference visibility direction.

In step S406, the trimming unit 48 trims an image captured by each of the wide-angle camera 49L and the wide-angle camera 49R under control by the trimming control unit 14C so as to conform to a corresponding recommended visibility direction.

### Effects of Seventh Embodiment

The side and rear reflection display device 27 of the seventh embodiment includes the trimming unit 48 that trims an image captured by each of the wide-angle cameras 49L and 49R as capturing devices. Each of the monitors 47L and 47R displays the image trimmed by the trimming unit 48. The trimming control unit 14C controls the range 61 of trimming by the trimming unit 48. Thus, a driver is allowed to visually recognize a recommended visibility direction through each of the monitors 47L and 47R.

### Eighth Embodiment

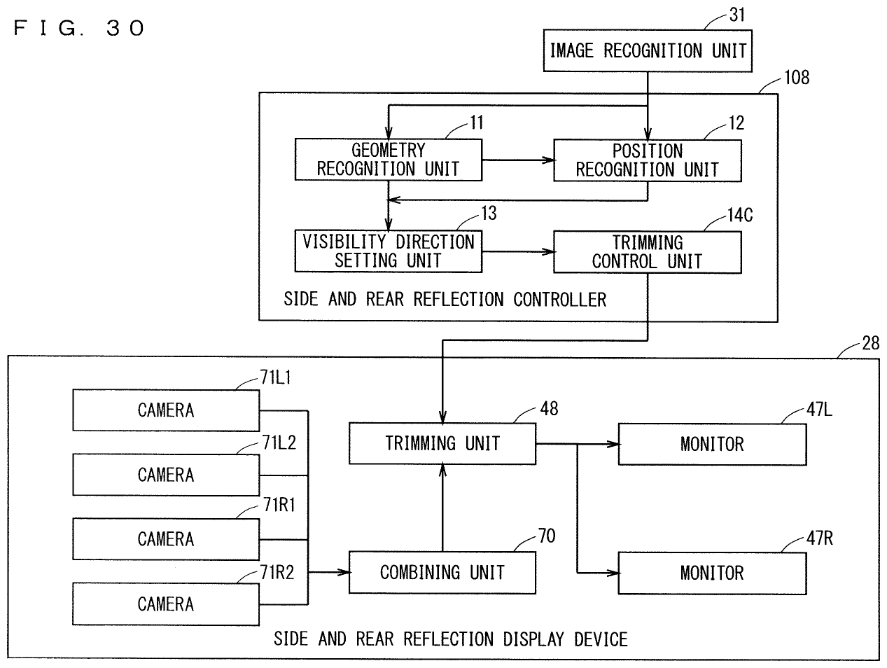

FIG. 30 is a block diagram showing the configuration of a side and rear reflection display system according to an eighth embodiment. A structure equal to or corresponding to that in the other embodiments is given the same sign in FIG. 30. The side and rear reflection display system of the eighth embodiment includes a side and rear reflection controller 107, a side and rear reflection display device 28, and the image recognition device 31. A structure equal to or corresponding to that in the other embodiments is given the same sign in FIG. 30.

The side and rear reflection controller 108 has the same configuration as the side and rear reflection controller 107.

The side and rear reflection display device 28 includes the trimming unit 48, the monitors 47L and 47R, a combining unit 70, a camera 71L1, a camera 71L2, a camera 71R1, and a camera 71R2. The cameras 71L1 and 71L2 are cameras mounted on the left front of the own vehicle A and used for capturing images of the left rear of the own vehicle A. The cameras 71L1 and 71L2 capture images in different directions. The cameras 71R1 and 71R2 are cameras mounted on the right front of the own vehicle A and used for capturing images of the right rear of the own vehicle A. The cameras 71R1 and 71R2 capture images in different directions.

The combining unit 70 combines an image captured by the camera 71L1 and an image captured by the camera 71L2 to generate one image. The combining unit 70 combines an image captured by the camera 71R1 and an image captured by the camera 71R2 to generate one image.

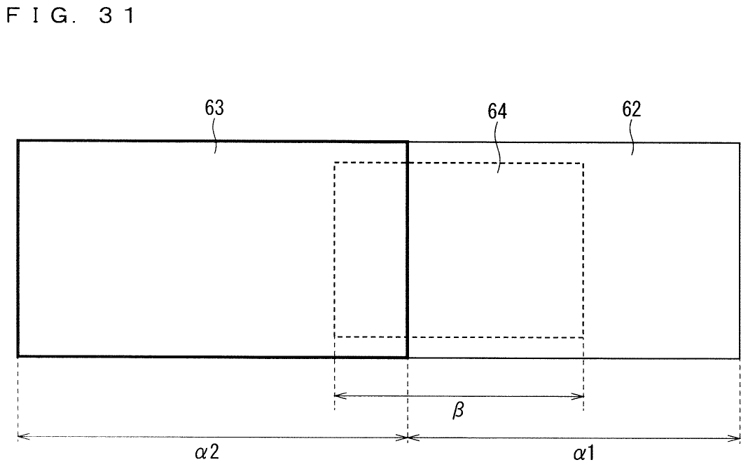

FIG. 31 shows a composite image of an image 62 captured by the camera 71L1 and an image 63 captured by the camera 71L2. An angle of view of the camera 71L1 is defined as α1, and an angle of view of the camera 71L2 is defined as α2. The trimming unit 48 trims a trimming range 64 of an angle of view β from the composite image. The trimming range 64 is displayed in the monitor 47L.

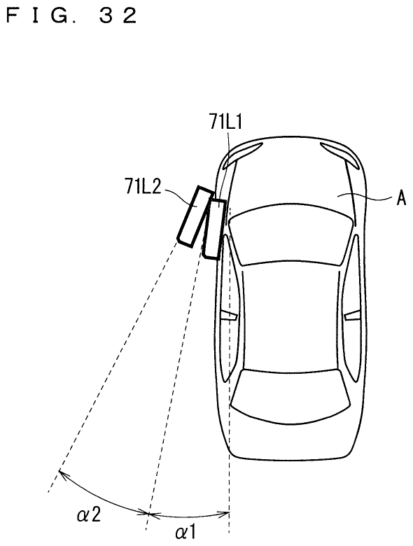

FIG. 32 shows the angle of view α1 of the camera 71L1 and the angle of view α2 of the camera 71L2. For example, α1 and α2 are 15°. The angle of view β of the trimming range 64 is 10°, for example. While the captured images of the left rear of the own vehicle A are described by referring to FIGS. 31 and 32, captured images of the right rear of the own vehicle A are combined and trimmed in the same way.

### Modifications of Eighth Embodiment

While the side and rear reflection display device 28 of the eighth embodiment includes the two monitors 47L and 47R, it may include one monitor.

A recommended visibility direction in the left rear of the own vehicle A is defined as a left recommended visibility direction. A reference visibility direction in the left rear of the own vehicle A is defined as a left reference visibility direction. A recommended visibility direction in the right rear of the own vehicle A is defined as a right recommended visibility direction. A reference visibility direction in the right rear of the own vehicle A is defined as a right reference visibility direction. The combining unit 70 combines an image in the left recommended visibility direction, an image in the left reference visibility direction, an image in the right reference visibility direction, and an image in the right recommended visibility direction in such a manner that these images are aligned side by side in this order. Then, in response to a direction of cornering by the own vehicle A at an intersection, the trimming unit 48 performs trimming so as to give a large ratio to an image on the side relating to the cornering. If the own vehicle A is to turn to the left, for example, the trimming unit 48 trims the image in the left recommended visibility direction, the image in the left reference visibility direction, and the image in the right reference visibility direction. If the own vehicle A is to turn to the right, the trimming unit 48 trims the image in the left reference visibility direction, the image in the right reference visibility direction, and the image in the right recommended visibility direction. This makes it possible to present necessary information in a monitor smaller than a monitor for displaying images in recommended visibility directions in both directions and images in reference visibility directions in both directions.

### Effects of Eighth Embodiment

In the side and rear reflection control system of the eighth embodiment, the side and rear reflection display device 28 includes the cameras 71L1, 71L2, 71R1, and 71R2 as a plurality of capturing devices that capture images in different directions. The side and rear reflection display device 28 includes the combining unit 70 that combines images captured by the cameras 71L1 and 71L2, and images captured by the cameras 71R1 and 71R2. The trimming unit 48 trims an image resulting from the combining by the combining unit 70. Thus, the eighth embodiment allows a recommended visibility direction to be displayed in each of the monitors 47L and 47R without using a wide-angle camera and without requiring adjustment of a direction of capturing by a camera.

In each of the configurations described in the seventh and eighth embodiments, the trimming unit 48 is incorporated into the side and rear reflection display device 27 or 28. Alternatively, the trimming unit 48 may be incorporated into the side and rear reflection controller 107 or 108.

### Ninth Embodiment

In the eighth embodiment, a monitor responsive to an angle of view of a recommended visibility direction is used. By contrast, a monitor used in a ninth embodiment is a horizontal monitor having a wide display range and allowing display of an image captured by a wide-angle camera without trimming of this image.

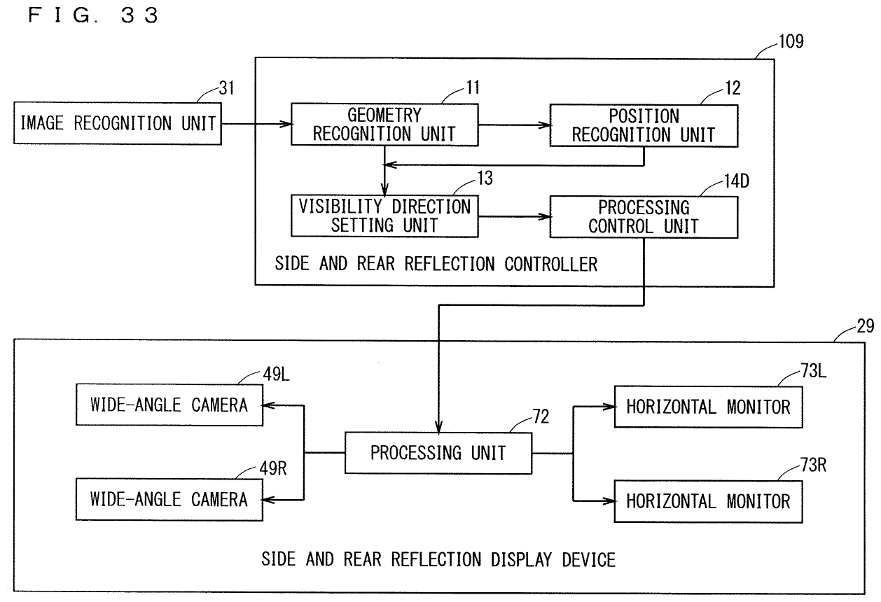

FIG. 33 is a block diagram showing the configuration of a side and rear reflection display system according to the ninth embodiment. A structure equal to or corresponding to that in the other embodiments is given the same sign in FIG. 33. The side and rear reflection display system of the ninth embodiment includes a side and rear reflection controller 109, a side and rear reflection display device 29, and the image recognition device 31.

The side and rear reflection controller 109 includes the geometry recognition unit 11, the position recognition unit 12, the visibility direction setting unit 13, and a processing control unit 14D. The processing control unit 14D controls processing by a processing unit 72 in the side and rear reflection display device 29.

The side and rear reflection display device 29 includes the wide-angle cameras 49L and 49R, the processing unit 72, a horizontal monitor 73L, and a horizontal monitor 73R. The processing unit 72 performs processing on images captured by each of the wide-angle cameras 49L and 49R in such a manner that a recommended visibility direction and other directions can be distinguished from each other.

The horizontal monitor 73L displays an image captured by the wide-angle camera 49L and processed by the processing unit 72. The horizontal monitor 73R displays an image captured by the wide-angle camera 49R and processed by the processing unit 72.

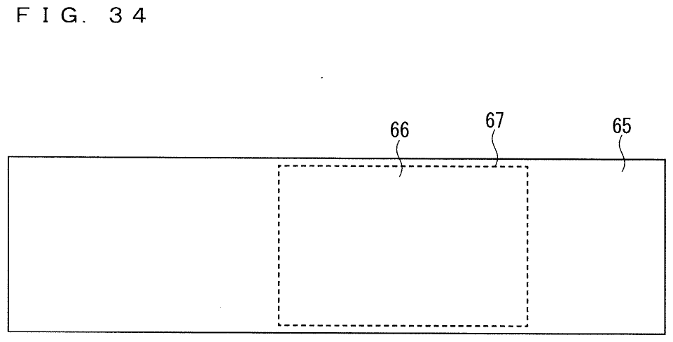

FIG. 34 shows an example of an image 65 captured by the wide-angle camera 49L or 49R and displayed in the horizontal monitor 73L. The captured image 65 includes a region 66 corresponding to a recommended visibility direction and surrounded by a frame 67. Namely, the processing unit 72 performs process of superimposing the frame 67 on the region corresponding to the recommended visibility direction from the image 65 captured by the wide-angle camera 49L or 49R. This allows a driver to visually recognize the interior of the frame 66 as the recommended visibility region easily. Further, the side and rear reflection display device 28 is not required to perform process of trimming the captured image 65, allowing implementation of image processing at high speed.

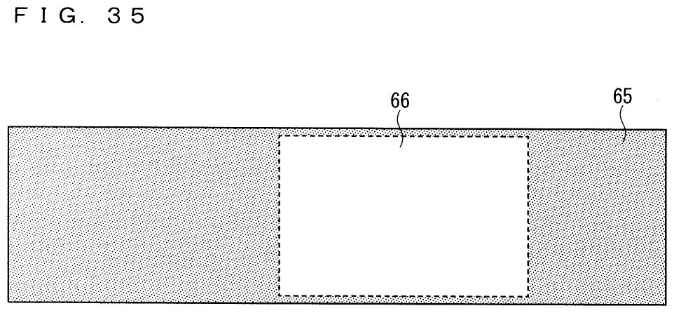

Alternatively, as shown in FIG. 35, a region in the image 65 captured by the wide-angle camera 49L or 49R and other than the region 66 corresponding to the recommended visibility direction may be subjected to image processing for semi-transparency, for example. This image processing is not limited to processing for semi-transparency but may be different processing for making presentation hard to see such as blurring, brightness change, or shading, for example. This makes it difficult for a driver to visually recognize a reflection other than a reflection in the recommended visibility direction, so that the driver is encouraged to pay attention to the reflection in the recommended visibility direction easily.

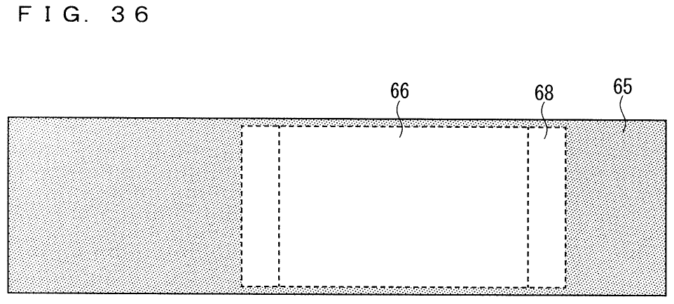

As shown in FIG. 36, in consideration of dynamical change of a recommended visibility direction, not only the region 66 corresponding to the recommended visibility direction but also a neighboring region 68 around the region 66 may be released from the foregoing processing of making presentation hard to see. In this case, the processing control unit 14D may predict a changed direction of the recommended visibility direction, and decide the width of the neighboring region 68 in response to the predicted changed direction or change speed. For example, if the recommended visibility direction is predicted to change to the right direction, the processing control unit 14D may increase the width of the neighboring region 68 on the right side of the region 66 corresponding to the recommended visibility direction.

### Effects of Ninth Embodiment

According to the ninth embodiment, the processing control unit 14D of the side and rear reflection controller 109 controls the side and rear reflection display device 29 in such a manner that a reflection in a recommended visibility direction and a reflection in a direction adjacent to the recommended visibility direction from the side and rear of an own vehicle are displayed in different fashions in each of the horizontal monitors 73L and 73R. In this case, the processing control unit 14D allows a driver to visually recognize the recommended visibility direction without the need of trimming. As a result, speed of image processing by the side and rear reflection display device 29 is increased.

In the configuration described in the ninth embodiment, the processing unit 72 is incorporated into the side and rear reflection display device 29. Alternatively, the processing unit 72 may be incorporated into the side and rear reflection controller 109.

### Tenth Embodiment

In the side and rear reflection controllers of the second to ninth embodiments, image recognition information from the image recognition device 31 is used for recognizing the geometry of a road in a neighborhood of the own vehicle A and the position of the own vehicle A relative to the neighboring road. By contrast, according to a tenth embodiment, the geometry of a road in a neighborhood of the own vehicle A and the position of the own vehicle A relative to the neighboring road are recognized by referring to map data containing a road geometry.

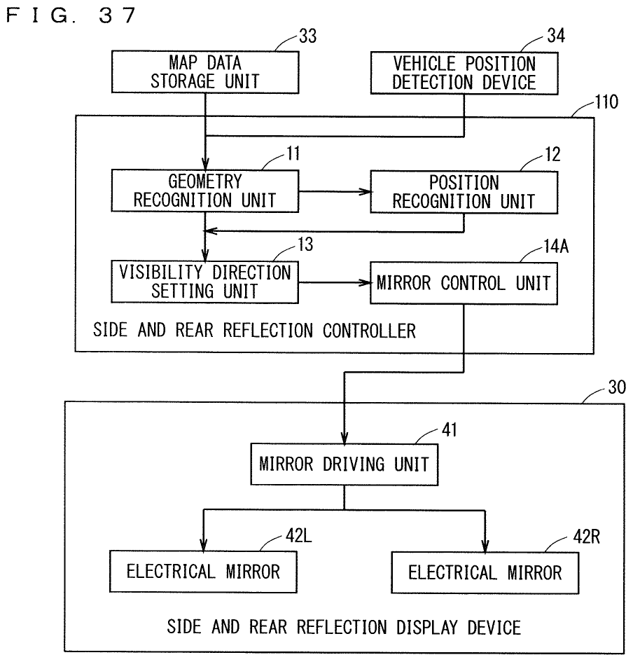

FIG. 37 is a block diagram showing the configuration of a side and rear reflection display system according to the tenth embodiment. The side and rear reflection display system of the tenth embodiment includes a side and rear reflection controller 110, a side and rear reflection display device 30, a map data storage unit 33, and a vehicle position detection device 34.

The side and rear reflection controller 110 has the same configuration as the side and rear reflection controller 102 of the second embodiment. The side and rear reflection display device 30 has the same configuration as the side and rear reflection display device 22 of the second embodiment.

The map data storage unit 33 stores the map data. The map data contains structure information about a road. The structure information about the road includes geometry information about the road, geometry information about a lane, course restriction on each lane, and geometry information about an intersection. The map data storage unit 33 may be mounted on the own vehicle A or provided in a server outside the own vehicle A.

The vehicle position detection device 34 detects the absolute position of the own vehicle A using a navigation satellite system (NSS) such as a global positioning system (GPS) or a quasi-zenith satellite system (QZSS), and a vehicle sensor such as a vehicle speed sensor or an acceleration sensor mounted on the own vehicle A.

FIG. 37 shows the map data storage unit 33 and the vehicle position detection device 34 as structures external to the side and rear reflection controller 110. However, at least one of these structures may be incorporated into the side and rear reflection controller 110. Alternatively, the map data storage unit 33 and the vehicle position detection device 34 may be configured integrally.

The geometry recognition unit 11 acquires the absolute position of the own vehicle A from the vehicle position detection device 34, and acquires structure information about a road in a neighborhood of the own vehicle A from the map data on the basis of the acquired absolute position. By doing so, the geometry recognition unit 11 recognizes the geometry of the road in the neighborhood of the own vehicle A.

The position recognition unit 12 acquires the absolute position of the own vehicle A from the vehicle position detection device 34. The position recognition unit 12 may perform map matching using the map data acquired from the map data storage unit 33, and compensate for the absolute position of the own vehicle A acquired from the vehicle position detection device 34. On the basis of the absolute position of the own vehicle A and the geometry of the road in the neighborhood of the own vehicle A recognized by the geometry recognition unit 11, the position recognition unit 12 grasps the position of the own vehicle A relative to the neighboring road.

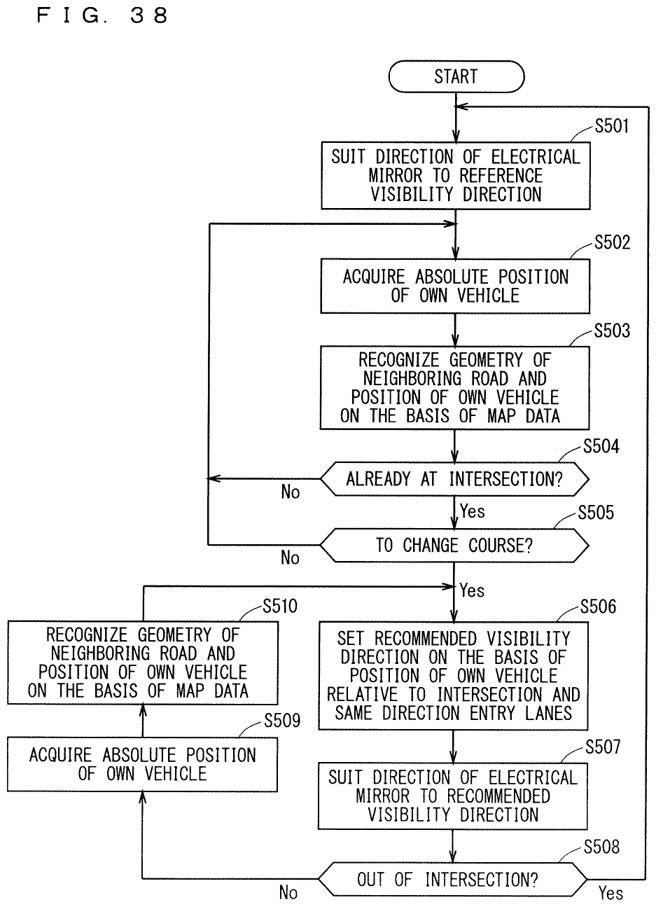

FIG. 38 is a flowchart showing the operation of the side and rear reflection display system according to the tenth embodiment. Steps S501 and S504 to 508 in the flow of FIG. 37 are the same as steps S201 and S204 to 207 respectively in the flow of the second embodiment shown in FIG. 4. The flow of FIG. 37 differs from the flow of FIG. 4 only in steps S502, S503, S509, and S510.

After step S501, the geometry recognition unit 11 acquires the absolute position of the own vehicle A from the vehicle position detection device 34 (step S502).

After step S502, the geometry recognition unit 11 refers to the map data in the map data storage unit 33 on the basis of the absolute position of the own vehicle A to acquire the structure of a road in a neighborhood of the own vehicle A. Then, on the basis of the road structure in the neighborhood of the own vehicle A and the absolute position of the own vehicle A, the position recognition unit 12 grasps the position of the own vehicle A relative to the neighboring road (step S503).

In step S508, the visibility direction setting unit 13 determines whether the own vehicle has exited an intersection. If the own vehicle has not exited the intersection, the processing by the side and rear reflection display system goes to step S509.

In step S509, the geometry recognition unit 11 acquires the absolute position of the own vehicle A in the same way as in step S502.

After step S509, the geometry recognition unit 11 acquire the structure of a road in a neighborhood of the own vehicle A in the same way as in step S503. Then, the position recognition unit 12 grasps the position of the own vehicle A relative to the neighboring road in the same way as in step S503 (step S510).

After step S510, the processing by the side and rear reflection display system goes to step S506.

Like the side and rear reflection controllers 102 to 109 of the second to ninth embodiments, the side and rear reflection controller 110 of the tenth embodiment may be connected to the image recognition device 31. In this case, the side and rear reflection controller 110 grasps the position of the own vehicle A relative to a neighboring road using image recognition information from the image recognition device 31, the map data, and the absolute position of the own vehicle A. For example, the position recognition unit 12 can compensate for the absolute position of the own vehicle A detected by the NSS on the basis of the image recognition information from the image recognition device 31. Further, the position recognition unit 12 can compensate for the position of the own vehicle A in an intersection on the basis of the image recognition information from the image recognition device 31.

The geometry recognition unit 11 can learn the structure of a road in a neighborhood of the own vehicle in advance from the map data. Thus, the geometry recognition unit 11 is not to recognize a road structure from a state with absolutely no information but narrows down a recognition target by using a road structure already known to some extent, thereby simplifying the image processing.

The tenth embodiment is devised by applying the method of recognizing a road structure using map data to the second embodiment. The method of recognizing a road structure using map data described in the tenth embodiment is further applicable to the other embodiments.

### Effects of Tenth Embodiment

In the side and rear reflection controller 110 of the tenth embodiment, the geometry recognition unit 11 recognizes the geometry of an intersection by referring to map data. This allows the side and rear reflection controller 110 to grasp the geometry of the intersection correctly by referring to the map data, and set a recommended visibility direction correctly on the basis of the grasped geometry.

<Hardware Configuration>

The structure of each part in each of the foregoing side and rear reflection controllers 101 to 110 is realized by a processing circuit 81 shown in FIG. 39. More specifically, the processing circuit 81 includes the geometry recognition unit 11, the position recognition unit 12, the visibility direction setting unit 13, the control unit 14, the mirror control unit 14A, the camera control unit 14B, the trimming control unit 14C, and the processing control unit 14D (hereinafter called “units including the geometry recognition unit 11”). The processing circuit 81 may be dedicated hardware or a processor to execute a program stored in a memory. The processor is a central processing unit, a processing device, an arithmetic device, a microprocessor, a microcomputer, or a digital signal processor (DSP), for example.

If the processing circuit 81 is dedicated hardware, the processing circuit 81 corresponds to a single circuit, a complex circuit, a programmed processor, a parallel-programmed processor, an application specific integrated circuit (ASIC), a field-programmable gate array (FPGA), or a combination of these units, for example. The respective functions of the units including the geometry recognition unit 11 may be realized by a plurality of processing circuits 81. Alternatively, the respective functions of these units may be realized together by one processing circuit.

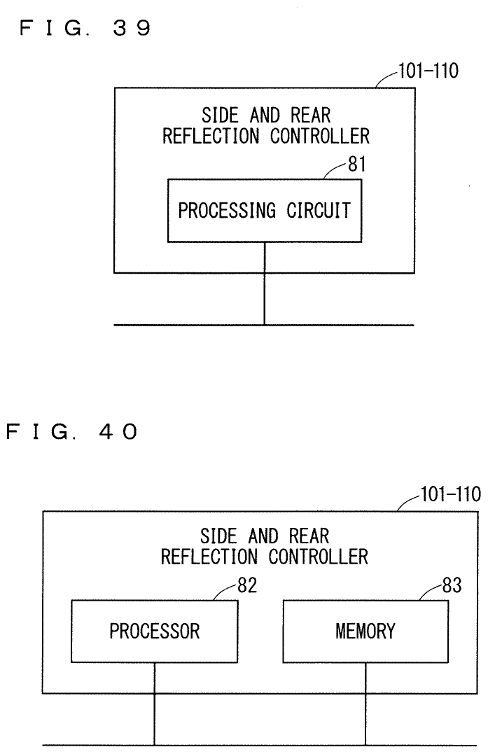

If the processing circuit 81 is a processor, the functions of the units including the geometry recognition unit 11 are realized by combination with software, etc. (software, firmware, or software and firmware). Such software is described as a program and stored into a memory. As shown in FIG. 40, a processor 82 applied to the processing circuit 81 reads and executes a program stored in a memory 83, thereby realizing the functions of the corresponding units. More specifically, each of the side and rear reflection controllers 101 to 110 includes the memory 83 for storing a program. The execution of this program by the processing circuit 81 results in implementation of: a step of recognizing the geometry of an intersection having same direction entry lanes; a step of grasping the position of an own vehicle relative to the intersection on the basis of the geometry of the intersection; a step of setting a part from the side and rear of the own vehicle as a recommended visibility direction on the basis of the position of the own vehicle relative to the intersection and the same direction entry lanes when the own vehicle changes a course at the intersection; and a step of controlling the side and rear reflection display device so as to present an image in the recommended visibility direction to a driver. In other words, this program can be said to be a program for causing a computer to implement procedures or methods to be taken by the units including the geometry recognition unit 11. For example, the memory 83 can be a nonvolatile or volatile semiconductor memory such as a random access memory (RAM), a read only memory (ROM), a flash memory, an erasable programmable read only memory (EPROM) or an electrically erasable programmable read only memory (EEPROM), a hard disk drive (HDD), a magnetic disk, a flexible disk, an optical disk, a compact disk, a minidisk, a digital versatile disc (DVD) and drivers thereof, or every type of storage medium to be used in the future.

In the foregoing configuration, the functions of the units including the geometry recognition unit 11 are realized by one of hardware and software, etc. However, this is not the limited configuration but some of the units including the geometry recognition unit 11 may be realized by dedicated hardware, and other of the units may be realized by software, etc. For example, the function of the visibility direction setting unit 13 may be realized by a processing circuit as dedicated hardware, and the functions of the other units may be realized by reading and execution of the program stored in the memory 83 by the processing circuit 81 as the processor 82.

As described above, the processing circuit 81 is capable of realizing each of the foregoing functions using hardware, software, etc. or combination of hardware and software, etc.

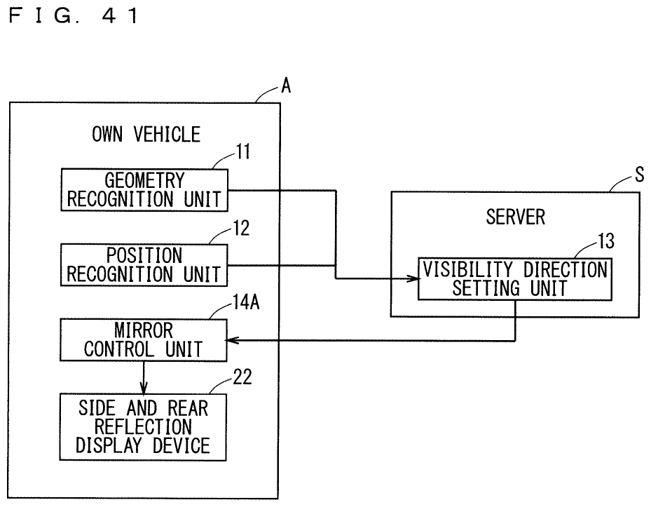

In addition to being configured as a vehicle-mounted device, each of the side and rear reflection controllers 101 to 110 is applicable to a system configured by combining a vehicle-mounted device, a portable navigation device (PND), a communication terminal (portable terminal such as mobile phone, smartphone, or tablet, for example), functions of applications installed on these devices, and a server appropriately. In this case, the foregoing functions or constituting elements of each of the side and rear reflection controllers 101 to 110 may be distributed to the devices constituting the system, or may be centralized in any of the devices. FIG. 41 shows an exemplary configuration of the side and rear reflection controller 102 according to the second embodiment configured using the own vehicle A and a server S. The geometry recognition unit 11, the position recognition unit 12, the mirror control unit 14A, and the side and rear reflection display device 22 are located in the own vehicle A. The visibility direction setting unit 13 is located in the server S.

The present invention is feasible by combining all the embodiments freely, or if appropriate, by modifying or omitting each embodiment within the scope of the invention.

While the invention has been shown and described in detail, the foregoing description is in all aspects illustrative and not restrictive. It is therefore understood that numerous modifications not shown can be devised without departing from the scope of the invention.

### EXPLANATION OF REFERENCE SIGNS

11 Geometry recognition unit
12 Position recognition unit
13 Visibility direction setting unit
14 Control unit
14A Mirror control unit
14B Camera control unit
14C Trimming control unit
14D Processing control unit
21, 22, 23, 24, 25, 25, 26, 27, 28, 29, 30 Side and rear reflection display device
31 Image recognition device
32 Neighboring moving object detection device
33 Map data storage unit
34 Vehicle position detection device
41 Mirror driving unit
42L, 42R, 421L, 421R Electrical mirror
43 Housing
44 Mirror surface
45 Camera driving unit
46L, 46R, 71L1, 71L2, 71R1, 71R2 Camera
47L, 47R Monitor
48 Trimming unit
49L, 49R Wide-angle camera
50L, 50R Reference visibility direction
51L, 51R Recommended visibility direction
52 Pedestrian crossing
60, 62, 63, 65 Captured image
61, 64 Trimming range
68 Neighboring region
70 Combining unit
72 Processing unit
73L, 73R Horizontal monitor
81 Processing circuit
82 Processor
83 Memory
101, 102, 103, 104, 105, 106, 107, 108, 109, 110 Side and rear reflection controller

1. A side and rear reflection controller that controls a side and rear reflection display device to present a reflection from the side and rear of an own vehicle to a driver, comprising:
a processor to execute a program; and
a memory to store the program which, when executed by the processor, performs processes of,
recognizing the geometry of an intersection having same direction entry lanes as a plurality of entry lanes allowing course change to the same direction;
recognizing the position of the own vehicle relative to the intersection on the basis of the geometry of the intersection;
setting a part from the side and rear of the own vehicle as a recommended visibility direction on the basis of the position of the own vehicle relative to the intersection and the same direction entry lanes when the own vehicle changes a course at the intersection; and
controlling the side and rear reflection display device so as to present an image in the recommended visibility direction to the driver.

2. The side and rear reflection controller according to claim 1, wherein
the side and rear reflection display device has a display surface with a first region and a second region, and
when executed by the processor, the program performs processes of,
setting a particular direction from the side and rear of the own vehicle and based on the own vehicle as a reference visibility direction; and
controlling the side and rear reflection display device so as to display a reflection in the recommended visibility direction in the first region and display a reflection in the reference visibility direction in the second region.

3. The side and rear reflection controller according to claim 1, wherein
when executed by the processor, the program performs processes of,
setting a particular direction from the side and rear of the own vehicle and based on the own vehicle as a reference visibility direction, and
controlling the side and rear reflection display device so as to make a switch of a presentation to the driver between a reflection in the recommended visibility direction and a reflection in the reference visibility direction.

4. The side and rear reflection controller according to claim 1, wherein
when executed by the processor, the program performs processes of
recognizing the geometry of the intersection on the basis of a captured image of a periphery of the own vehicle.

5. The side and rear reflection controller according to claim 1, wherein
when executed by the processor, the program performs processes of
recognizing the geometry of the intersection by referring to map data.

6. The side and rear reflection controller according to claim 1, wherein
the side and rear reflection display device includes an electrical mirror of the own vehicle, and
when executed by the processor, the program performs processes of
controlling the direction of the electrical mirror.

7. The side and rear reflection controller according to claim 1, wherein the side and rear reflection display device includes:
a capturing device that captures an image of the side and rear of the own vehicle; and
a monitor mounted on the own vehicle for display of the image captured by the capturing device.

8. The side and rear reflection controller according to claim 7, wherein
when executed by the processor, the program performs processes of
controlling a direction of capturing by the capturing device.

9. The side and rear reflection controller according to claim 7, wherein
the image captured by the capturing device is trimmed in the side and rear reflection display device,
the monitor displays the trimmed image, and
when executed by the processor, the program performs processes of
controlling a range of trimming of the captured image.

10. The side and rear reflection controller according to claim 9, wherein
the capturing device is a plurality of cameras that capture images in different directions,
the images captured by the cameras are combined in the side and rear reflection display device, and
the monitor displays the images resulting from the trimming of the combined images.

11. The side and rear reflection controller according to claim 7, wherein
a reflection in the recommended visibility direction is displayed in a part of a display region of the monitor.

12. The side and rear reflection controller according to claim 1, wherein
when executed by the processor, the program performs processes of,
recognizing the geometries of the same direction entry lanes,
grasping the position of the own vehicle relative to extensions of the same direction entry lanes to the intersection on the basis of the geometries of the same direction entry lanes, and
setting the recommended visibility direction on the basis of the position of the own vehicle relative to the extensions of the same direction entry lanes to the intersection.

13. The side and rear reflection controller according to claim 1, wherein
when executed by the processor, the program performs processes of,
recognizing the direction of the own vehicle relative to the intersection on the basis of the geometry of the intersection, and
setting the recommended visibility direction on the basis of the direction of the own vehicle relative to the intersection.

14. The side and rear reflection controller according to claim 1, wherein
when executed by the processor, the program performs processes of,
recognizing the presence or absence of a pedestrian crossing on an exit lane from the intersection, and
setting the recommended visibility direction on the basis of the presence or absence of the pedestrian crossing.

15. The side and rear reflection controller according to claim 14, wherein
when executed by the processor, the program performs processes of
setting the recommended visibility direction on the basis of position information about a moving object driving in a neighborhood of the own vehicle.

16. A side and rear reflection control method of controlling a side and rear reflection display device to present a reflection from the side and rear of an own vehicle to a driver, comprising:
recognizing the geometry of an intersection having same direction entry lanes as a plurality of entry lanes allowing course change to the same direction;
recognizing the position of the own vehicle relative to the intersection on the basis of the geometry of the intersection;
setting a part from the side and rear of the own vehicle as a recommended visibility direction on the basis of the position of the own vehicle relative to the intersection and the same direction entry lanes when the own vehicle changes a course at the intersection; and
controlling the side and rear reflection display device so as to present an image in the recommended visibility direction to the driver.
